(19) United States
(12) Patent Application Publication
(10) Pub. No.: US 2026/0188950 A1
(43) Pub. Date: Jul. 2, 2026

(54) CONNECTOR

(71) Applicant: Bellwether Electronic Corp., Taoyuan City (TW)

(72) Inventors: Yu-Hung YEN, Taoyuan City (TW); Yu-Yang HSU, Taoyuan City (TW)

(21) Appl. No.: 19/412,792

(22) Filed: Dec. 8, 2025

Related U.S. Application Data
(60) Provisional application No. 63/739,124, filed on Dec. 27, 2024.
(60) Provisional application No. 63/741,420, filed on Jan. 3, 2025.

(51) Int. Cl. H01R 13/633; H01R 13/506; H01R 13/58; H01R 13/627

(52) U.S. Cl. CPC H01R 13/633; H01R 13/506; H01R 13/5816; H01R 13/6272

(57) ABSTRACT

A connector includes a terminal body, a first housing, and a pull tab. The terminal body includes a main body and a latch disposed on the main body. The latch includes an elastic arm, a pressing portion located at an end of the elastic arm, and a hook located at the other end of the elastic arm. The first housing has a first accommodating space accommodating the terminal body. The pull tab passes through the first accommodating space. The pull tab includes an actuating portion and a limiting opening located on the actuating portion. The actuating portion has an actuating inclined surface located on an inner surface of the limiting opening. When the pull tab moves away from the terminal body, the actuating inclined surface abuts against an abutting inclined surface, such that the latch seesaws relative to the main body.

### CROSS-REFERENCE TO RELATED APPLICATION

This application claims priority to U.S. Provisional Application Ser. No. 63/739,124 filed Dec. 27, 2024, and U.S. Provisional Application Ser. No. 63/741,420 filed Jan. 3, 2025, the disclosures of which are incorporated herein by reference in their entireties.

### BACKGROUND

### Field of Invention

The present invention relates to a connector, especially a cable-end connector.

### Description of Related Art

In general, electrical connection is implemented through a connector, whether between a cable and a circuit board or between a cable and a busbar.

However, as the overall current demand of systems increases, the number of conductive terminals on the connector and the overall size of the connector likewise increase. Different system configurations correspond to different current requirements. Since cable-end connectors are generally specified with fixed specifications (i.e., fixed rated current specifications), the demand for different current capacities results in the need for a corresponding increase in the types of connectors, which further leads to increased production and inventory costs.

Therefore, how to propose a connector that can solve the aforementioned problems is one of the problems that the industry is currently eager to invest in research and development resources to solve.

### SUMMARY

In view of this, one purpose of the present disclosure is to provide a connector that can solve the aforementioned problems.

In order to achieve the above objective, in accordance with an embodiment of the present disclosure, a connector includes a terminal body, a first housing, and a pull tab. The terminal body includes a main body and a latch disposed on the main body. The latch includes an elastic arm, a pressing portion located at an end of the elastic arm, and a hook located at the other end of the elastic arm. The pressing portion has an abutting inclined surface. The first housing has a first accommodating space accommodating the terminal body. The pull tab passes through the first accommodating space. The pull tab includes an actuating portion and a limiting opening located on the actuating portion. The actuating portion has an actuating inclined surface. The actuating inclined surface is located on an inner surface of the limiting opening. When the pull tab moves away from the terminal body, the actuating inclined surface abuts against the abutting inclined surface, such that the latch seesaws relative to the main body.

In one or more embodiments of the present disclosure, the connector further includes a second housing engaged with the first housing. The second housing has a second accommodating space. The terminal body further includes a flange located at at least one side of the main body. The flange is located between the first housing and the second housing.

In one or more embodiments of the present disclosure, the first housing includes a first bottom plate, two first side plates, and a first top plate defining the first accommodating space. The second housing includes two second side plates, a second top plate, and a second back plate defining the second accommodating space. The second housing has a cable exit opening defined by an edge of the first bottom plate, edges of the two second side plates, and an edge of the second back plate and has a communicating opening communicating the first accommodating space and the second accommodating space.

In one or more embodiments of the present disclosure, the pull tab further includes a grip portion, a connecting portion, and an extending portion. The grip portion is located outside the second housing and includes an anti-slip portion. An extending direction of the grip portion forms an acute angle with an extending direction of the actuating portion. The connecting portion is connected between the grip portion and the actuating portion. The extending portion is located at an end of the actuating portion away from the grip portion and laterally extends from the actuating portion. The extending portion has a first thickness, the connecting portion has a second thickness, and the actuating portion has a third thickness. The third thickness is greater than the second thickness and less than the first thickness.

In one or more embodiments of the present disclosure, the connector further includes a second housing engaged with the first housing. The second housing has a second accommodating space. The terminal body further includes a flange located at at least one side of the main body. The first housing includes a blocking bar and a blocking bump blocking the flange.

In one or more embodiments of the present disclosure, the first housing includes a first bottom plate, two first side plates, and a first top plate defining the first accommodating space. The second housing includes two second side plates, a second top plate, and a second back plate defining the second accommodating space. The first housing has a communicating opening communicating the first accommodating space and the second accommodating space. The second housing has a first cable exit opening defined by an edge of the first bottom plate, edges of the two second side plates, and an edge of the second back plate, a second cable exit opening running through the second side plates, and a pull tab exit running through the second back plate.

In one or more embodiments of the present disclosure, the first housing further includes a pressing arm extending from the first top plate and located over the pressing portion. A portion of the pressing arm protrudes from an outer surface of the first top plate.

In one or more embodiments of the present disclosure, the pull tab further includes a grip portion, a strap portion, and a fixing portion. The grip portion is connected to the actuating portion and includes an anti-slip portion. The strap portion is connected to a side of the actuating portion away from the grip portion and adjacent to the two first side plates. The fixing portion is connected to the strap portion and has a fixing slot running through the fixing portion. The fixing portion is fixed to a fixing bump of the first bottom plate by the fixing slot. A first end of the pull tab is located on the grip portion, and a second end of the pull tab is located on the fixing portion.

In one or more embodiments of the present disclosure, the terminal body further includes a flange located at at least one side of the main body. The first housing has a positioning slot engaged with the flange.

In one or more embodiments of the present disclosure, the connector further includes a retaining part disposed on the first housing. The first housing includes a first bottom plate, two first side plates connected to the first bottom plate, a first back plate connected to the two first side plates, and an extending plate extending from the two first side plates and engaged with the retaining part. The first bottom plate, the two first side plates, the first back plate, the extending plate, and the retaining part define the first accommodating space. The first housing has a communicating opening communicating with the first accommodating space and a cable exit opening running through the first bottom plate. The retaining part further includes a pressing arm located over the pressing portion.

In one or more embodiments of the present disclosure, the pull tab further includes a grip portion, a strap portion, and a fixing portion. The grip portion is connected to the actuating portion and includes an anti-slip portion. The strap portion is connected to a side of the actuating portion away from the grip portion and adjacent to the two first side plates. The fixing portion is connected to the strap portion. The fixing portion is integrally formed with the first bottom plate.

In order to achieve the above objective, in accordance with an embodiment of the present disclosure, a connector includes a terminal body, a first housing, and a pull tab. The terminal body includes a main body and a latch disposed on the main body. The latch includes an elastic arm, a pressing portion located at an end of the elastic arm, and a hook located at the other end of the elastic arm. The pressing portion has an abutting inclined surface. The first housing has a first accommodating space accommodating the terminal body. The pull tab passes through the first accommodating space and includes an actuating portion. The actuating portion has an actuating inclined surface facing the latch. When the pull tab moves away from the terminal body, the actuating inclined surface abuts against the abutting inclined surface, such that the latch seesaws relative to the main body.

In one or more embodiments of the present disclosure, the connector further includes a second housing engaged with the first housing. The second housing has a second accommodating space. The terminal body further includes a flange located at at least one side of the main body. The flange is located between the first housing and the second housing.

In one or more embodiments of the present disclosure, the first housing includes a first bottom plate, two first side plates, and a first top plate defining the first accommodating space. The second housing includes two second side plates, a second top plate, and a second back plate defining the second accommodating space. The second housing has a cable exit opening defined by an edge of the first bottom plate, edges of the two second side plates, and an edge of the second back plate and has a communicating opening communicating the first accommodating space and the second accommodating space.

In one or more embodiments of the present disclosure, the first housing includes a first bottom plate, two first side plates, and a first top plate defining the first accommodating space. The second housing includes a second bottom plate, two second side plates, a second back plate, and an extending housing connected to the second back plate and defining a pull tab channel, defining the second accommodating space. The pull tab channel divides the second accommodating space to form a first cable exit opening and a second cable exit opening. The second housing has a pull tab exit located at an end of the pull tab channel away from the first housing and has a communicating opening communicating the first accommodating space and the second accommodating space.

In one or more embodiments of the present disclosure, the first housing includes a first bottom plate, two first side plates, and a first top plate defining the first accommodating space. The second housing includes a second bottom plate, two second side plates, a second top plate, and a second back plate defining the second accommodating space. The first housing has a pull tab exit running through the first top plate and a communicating opening communicating the first accommodating space and the second accommodating space. The second housing has a cable exit opening running through one of the two second side plates.

In one or more embodiments of the present disclosure, the connector further includes a blocking arm extending from the first housing. The terminal body further includes a flange located at at least one side of the main body. The flange is located between an end of the blocking arm away from the terminal body and the first housing.

In one or more embodiments of the present disclosure, the first housing includes a first bottom plate, two first side plates, and a first top plate defining the first accommodating space. The first housing has a cable exit opening located at an end of the first accommodating space facing the blocking arm and a pull tab exit running through the first top plate.

In one or more embodiments of the present disclosure, the pull tab further includes a grip portion, a connecting portion, a blocking portion, and an extending portion. The grip portion is located outside the first housing. The connecting portion is connected between the grip portion and the actuating portion. The blocking portion is connected to a side of the actuating portion away from the grip portion and has a blocking inclined surface. A thickness of the blocking portion is greater than a thickness of the actuating portion. The extending portion is located at an end of the blocking portion away from the grip portion and laterally extends from the blocking portion.

In one or more embodiments of the present disclosure, the first housing further includes a guiding bump. When the pull tab moves away from the terminal body, the guiding bump guides the blocking inclined surface, such that the actuating portion presses the pressing portion toward the main body.

In summary, in the connector of the present disclosure, since the latch of the terminal body includes a pressing portion having an abutting inclined surface and the actuating portion of the pull tab includes an actuating inclined surface, when the pull tab is pulled to move in a direction away from the terminal body, the actuating inclined surface of the actuating portion abuts against the abutting inclined surface of the pressing portion, thereby causing both ends of the latch to seesaw, and thus achieving the purpose of unlocking the connector. In the connector of the present disclosure, since the blocking portion of the pull tab includes a guiding inclined surface, and the housing includes a guiding bump disposed corresponding to the guiding inclined surface, when the pull tab is pulled to move in a direction away from the terminal body, the guiding inclined surface of the blocking portion is guided by the guiding bump of the housing, thereby causing the actuating portion to press the pressing portion of the latch toward the main body, and thus achieving the effect of ensuring that the hook of the latch reliably disengages from the connector at the other end. Overall, the connector of the present disclosure can achieve the effect of making the insertion and removal operation of the entire connector more effortless.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view and an exploded view of a connector in accordance with an embodiment of the present disclosure;

FIG. 2 is a sided view of a pull tab in accordance with an embodiment of the present disclosure;

FIG. 3 is another perspective view of a connector in accordance with an embodiment of the present disclosure;

FIG. 4 is a cross-sectional view of a connector in accordance with an embodiment of the present disclosure;

FIG. 5 is cross-sectional views of a connector in a first state and a second state in accordance with an embodiment of the present disclosure;

FIG. 6 is a perspective view of a connector in accordance with an embodiment of the present disclosure;

FIG. 7 is another perspective view and an exploded view of a connector in accordance with an embodiment of the present disclosure;

FIG. 8 is a cross-sectional view of a connector in accordance with an embodiment of the present disclosure;

FIG. 9 is another cross-sectional view of a connector in accordance with an embodiment of the present disclosure;

FIG. 10 is a perspective view and an exploded view of a connector in accordance with an embodiment of the present disclosure;

FIG. 11 is a cross-sectional view of a connector in accordance with an embodiment of the present disclosure;

FIG. 12 is a perspective view and an exploded view of a connector in accordance with an embodiment of the present disclosure;

FIG. 13 is a sided view of a pull tab in accordance with an embodiment of the present disclosure;

FIG. 14 is a cross-sectional view of a connector in accordance with an embodiment of the present disclosure;

FIG. 15 is a cross-sectional view of a connector in a first state and a second state in accordance with an embodiment of the present disclosure;

FIG. 16 is a perspective view of a connector in accordance with an embodiment of the present disclosure;

FIG. 17 is another perspective view and an exploded view of a connector in accordance with an embodiment of the present disclosure;

FIG. 18 is a cross-sectional view of a connector in accordance with an embodiment of the present disclosure;

FIG. 19 is another cross-sectional view of a connector in accordance with an embodiment of the present disclosure;

FIG. 20 is a perspective view and an exploded view of a connector in accordance with an embodiment of the present disclosure;

FIG. 21 is a cross-sectional view of a connector in accordance with an embodiment of the present disclosure;

FIG. 22 is a perspective view and an exploded view of a connector in accordance with an embodiment of the present disclosure;

FIG. 23 is a cross-sectional view of a connector in accordance with an embodiment of the present disclosure;

FIG. 24 is a perspective view and an exploded view of a connector in accordance with an embodiment of the present disclosure; and

FIG. 25 is a cross-sectional view of a connector in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in a connector 100 of this embodiment and the connection relationship between the components will be described in detail.

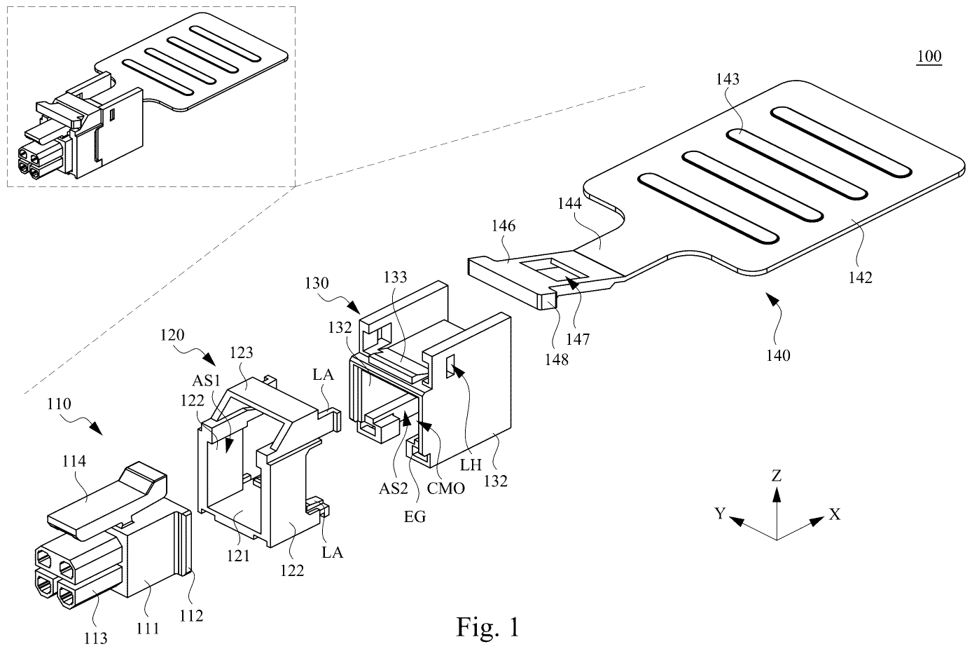

Reference is made to FIG. 1. In this embodiment, the connector 100 includes a terminal body 110, a first housing 120, a second housing 130, and a pull tab 140. The first housing 120 accommodates the terminal body 110. In detail, the terminal body 110 is partially located in the first housing 120. The second housing 130 is engaged with the first housing 120. The pull tab 140 at least passes through the first housing 120 and is configured to unlock the terminal body 110. Specifically, the connector 100 is connected to a connector at the other end (not shown) through the terminal body 110. Therefore, when the pull tab 140 is pulled, the terminal body 110 undergoes a temporary deformation to be unlocked and thus disengaged from the connector at the other end.

In some embodiments, the connector 100 may be, for example, a cable-end connector. However, the present disclosure is not intended to limit the type of the connector 100. The connector 100 is a rear-exit connector and is capable of supporting a cable to exit directly from a rear end opening of the second housing 130 without bending.

Reference is made again to FIG. 1. In this embodiment, the terminal body 110 includes a main body 111, a flange 112, a mating portion 113, and a latch 114. The flange 112 is located at at least one side of the main body 111 and protrudes from an outer surface of the main body 111. The mating portion 113 is connected to the main body 111 and is located at an end of the main body 111 away from the flange 112. The mating portion 113 is configured to mate with a conductive terminal (not shown) of the connector at the other end. The latch 114 is disposed on the main body 111 and is configured to seesaw relative to the outer surface of the main body 111. The first housing 120 includes a first bottom plate 121, two first side plates 122, a first top plate 123, and a locking arm LA. The first bottom plate 121, the two first side plates 122, and the first top plate 123 define a first accommodating space AS1 of the first housing 120. The locking arm LA extends from the first bottom plate 121 and the two first side plates 122. In some embodiments, the first housing 120 includes a plurality of locking arms LA, and the locking arms LA extend generally parallel to each other along a direction (e.g., direction X).

Reference is made again to FIG. 1. In this embodiment, the second housing 130 includes two second side plates 132, a second top plate 133, and an engaging portion EG. A second accommodating space AS2 of the second housing 130 is at least defined by the two second side plates 132 and the second top plate 133. The second housing 130 further includes a locking hole LH and a communicating opening CMO. The engaging portion EG and the locking hole LH are configured to be respectively engaged with the plurality of locking arms LA of the first housing 120. The communicating opening CMO communicates the first accommodating space AS1 and the second accommodating space AS2. The pull tab 140 is configured to at least pass through the first accommodating space AS1 of the first housing 120 and includes a grip portion 142, a connecting portion 144, an actuating portion 146, a limiting opening 147, and an extending portion 148. The grip portion 142 includes an anti-slip portion 143. In some embodiments, the anti-slip portion 143 protrudes from an outer surface of the grip portion 142. In some embodiments, the anti-slip portion 143 is bar-shaped. The connecting portion 144 is connected to one side of the grip portion 142. The actuating portion 146 is connected to the connecting portion 144 and is configured to abut against the latch 114. Specifically, the connecting portion 144 is connected between the grip portion 142 and the actuating portion 146. The limiting opening 147 is located on the actuating portion 146. In some embodiments, the limiting opening 147 runs through the actuating portion 146. The extending portion 148 is located at an end of the actuating portion 146 away from the grip portion 142. The extending portion 148 extends laterally from the actuating portion 146. In some embodiments, the extending portion 148 extends in a direction (e.g., direction Y) away from the actuating portion 146.

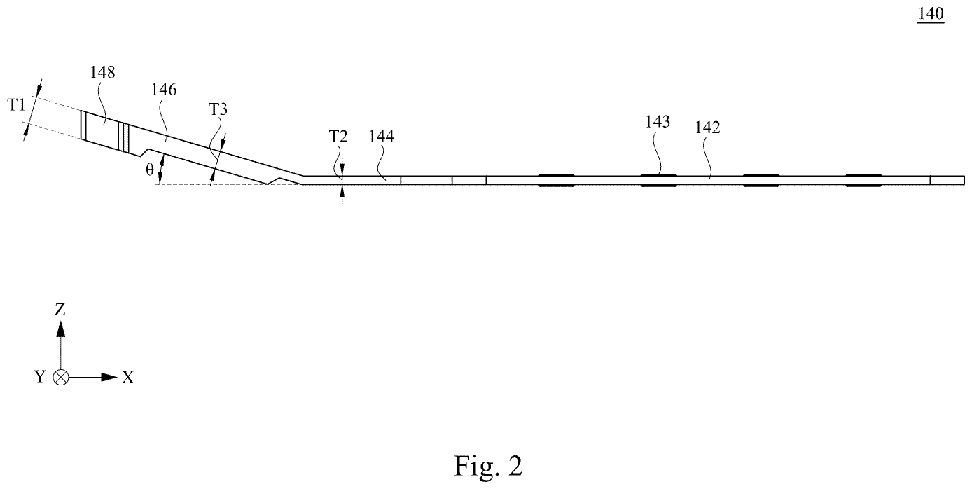

Reference is made to FIG. 2, which is a sided view of the pull tab 140 in accordance with an embodiment of the present disclosure. In this embodiment, an extending direction of the grip portion 142 forms an angle θ with an extending direction of the actuating portion 146. For example, the angle θ is an acute angle. In other words, the angle θ is less than 90 degrees. The extending portion 148 has a thickness T1, the connecting portion 144 has a thickness T2, and the actuating portion 146 has a thickness T3. In some embodiments, the thickness T3 is greater than the thickness T2 and less than the thickness T1. Since the thickness T2 is less than both the thickness T1 and the thickness T3, the volume occupied by the pull tab 140 can be reduced. Since the thickness T3 is greater than the thickness T2, the strength around the limiting opening 147 of the actuating portion 146 can be increased to prevent a risk of breakage of the actuating portion 146. Since the thickness T1 is greater than the thickness T3, when the pull tab 140 is excessively pulled, the extending portion 148 can be blocked by the first housing 120 to prevent the pull tab 140 from disengaging from the first housing 120.

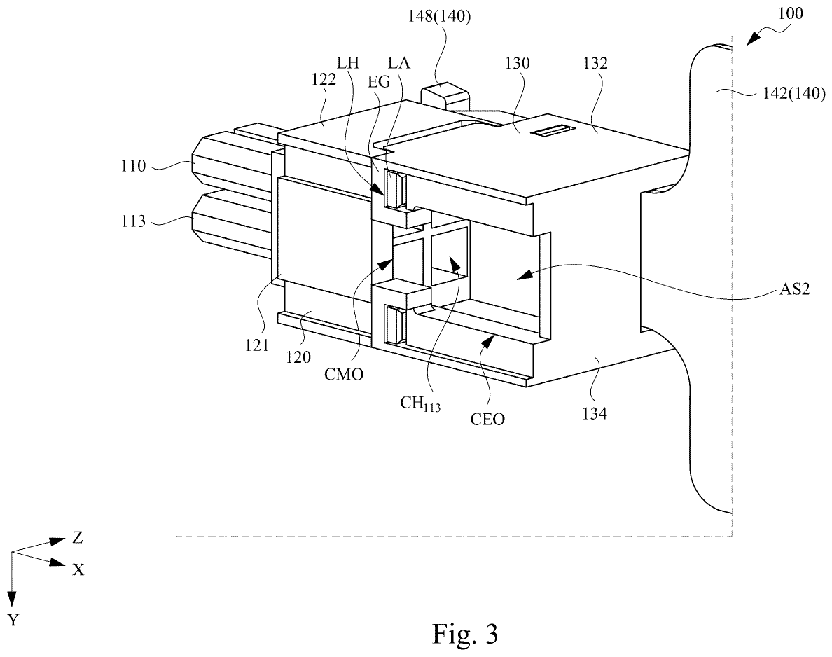

Reference is made to FIG. 3. In this embodiment, the terminal body 110 has a terminal channel CH₁₁₃ running through the main body 111 and the mating portion 113. The terminal channel CH₁₁₃ is configured to accommodate a conductive terminal and a cable (not shown) of the terminal body 110. The terminal channel CH₁₁₃ communicates the second accommodating space AS2 via the communicating opening CMO. The second housing 130 further includes a second back plate 134. Therefore, the second accommodating space AS2 is substantially defined by the two second side plates 132, the second top plate 133, and the second back plate 134. The second housing 130 further includes a cable exit opening CEO, and the cable exit opening CEO communicates the second accommodating space AS2. Specifically, the cable exit opening CEO is defined by an edge of the first bottom plate 121, edges of the two second side plates 132, and an edge of the second back plate 134. In a usage scenario, the aforementioned cable (not shown) passes through the second accommodating space AS2 from the terminal channel CH₁₁₃ and extends outward from the cable exit opening CEO. The extending portion 148 of the pull tab 140 is located outside the first housing 120.

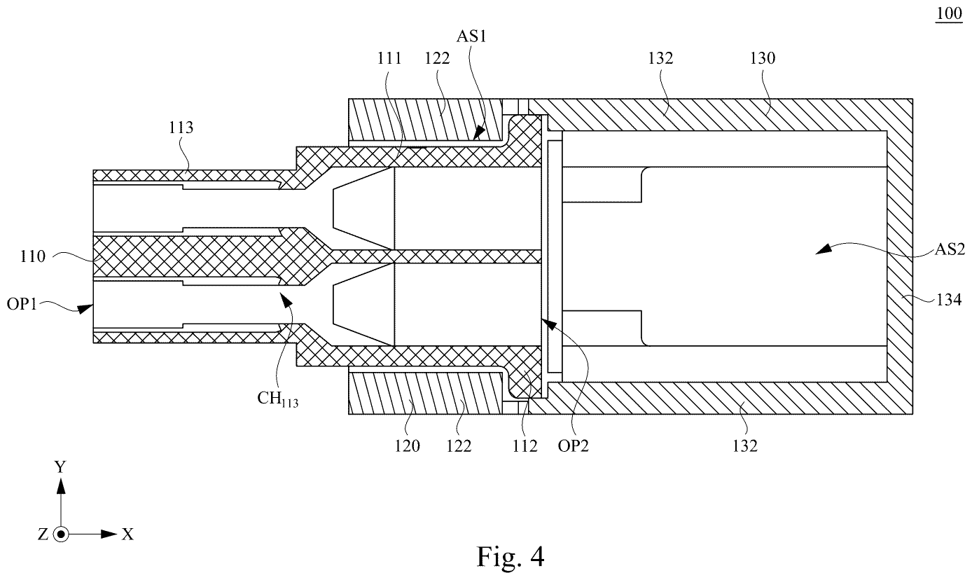

Reference is made to FIG. 4, which is a cross-sectional view of the connector 100 in accordance with an embodiment of the present disclosure. In this embodiment, the terminal channel CH₁₁₃ runs through the main body 111 and the mating portion 113 of the terminal body 110. Two ends of the terminal channel CH₁₁₃ respectively have a first opening OP1 located on the mating portion 113 and a second opening OP2 located on the main body 111. The second opening OP2 communicates the second accommodating space AS2. The flange 112 is located between the first housing 120 and the second housing 130. Specifically, since a step is formed between the flange 112 and the main body 111, the flange 112 can be limited by the first side plate 122 and the second side plate 132, thereby allowing the terminal body 110 to be positioned within the first housing 120 and the second housing 130.

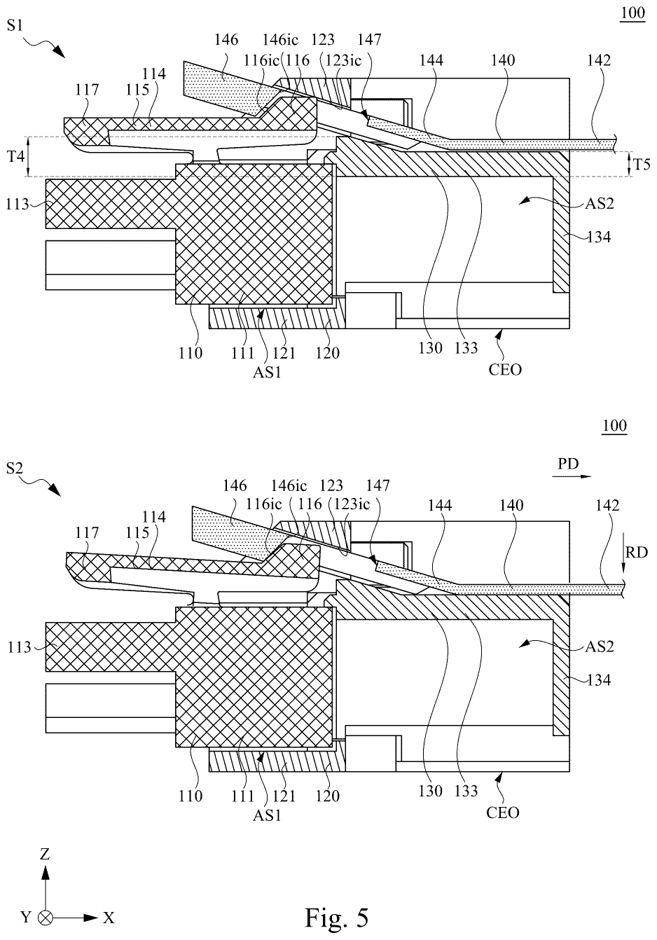

Reference is made to FIG. 5, which is a cross-sectional view of the connector 100 in a first state S1 and a second state S2 in accordance with an embodiment of the present disclosure. In this embodiment, the latch 114 further includes an elastic arm 115, a pressing portion 116, and a hook 117. The pressing portion 116 is located at an end of the elastic arm 115, and the hook 117 is located at the other end of the elastic arm 115. The pressing portion 116 has an abutting inclined surface 116ic. The actuating portion 146 has an actuating inclined surface 146ic, and the actuating inclined surface 146ic is located on an inner surface of the limiting opening 147. When the connector 100 is in the first state S1, the pressing portion 116 of the latch 114 is located in the limiting opening 147 of the actuating portion 146, and an extending direction of the elastic arm 115 of the latch 114 is parallel to direction X (i.e., the elastic arm 115 is in a generally horizontally extending state). The grip portion 142 of the pull tab 140 is located outside the second housing 130. Specifically, the grip portion 142 is located over the second top plate 133 and outside the second accommodating space AS2. The first top plate 123 covers the actuating portion 146 and is located over the pressing portion 116. The second top plate 133 is lower than the first top plate 123, so that the pull tab 140 can pass through a gap between the first top plate 123 and the second top plate 133. The first top plate 123 has a guiding inclined surface 123ic facing the pressing portion 116. In some embodiments, an extending direction of the guiding inclined surface 123ic is parallel to an extending direction of the actuating portion 146.

Reference is made again to FIG. 5. In this embodiment, when the connector 100 is altered from the first state S1 to the second state S2, the pull tab 140 moves away from the terminal body 110 along a pulling direction PD that is generally parallel to direction X. As the pull tab 140 moves away from the terminal body 110, the actuating inclined surface 146ic of the actuating portion 146 abuts against the abutting inclined surface 116ic of the pressing portion 116, such that the latch 114 seesaws relative to the main body 111. Specifically, an extending direction of the actuating inclined surface 146ic forms an acute angle with the pulling direction PD (i.e., the extending direction of the actuating inclined surface 146ic is neither perpendicular nor parallel to the pulling direction PD), such that the actuating portion 146 presses the pressing portion 116 of the latch 114 toward the main body 111 along a pressing direction RD that is generally parallel to direction Z, thereby causing the pressing portion 116 to move downward and the hook 117 to move upward. In some embodiments, the pulling direction PD is perpendicular to the pressing direction RD, but not limited thereto. In a usage scenario, a user may grip the grip portion 142 of the pull tab 140 and pull the pull tab 140 along the pulling direction PD, such that the actuating portion 146 of the pull tab 140 presses the pressing portion 116 of the latch 114 downward by the guiding of the actuating inclined surface 146ic and the abutting inclined surface 116ic, thereby causing the hook 117 to tilt upward and disengage from the connector at the other end.

As shown in FIG. 5, in some embodiments, an end of the second top plate 133 close to the first housing 120 has a thickness T4, and an end of the second top plate 133 away from the first housing 120 has a thickness T5. The thickness T4 is greater than the thickness T5. This ensures that when the pull tab 140 is pulled and drives the terminal body 110 to abut against the second housing 130, the second top plate 133 can provide sufficient supporting force, thereby achieving the effect of enhancing the structural strength of the connector 100.

Hereinafter, the structure and function of each component included in a connector 200 of this embodiment and the connection relationship between the components will be described in detail.

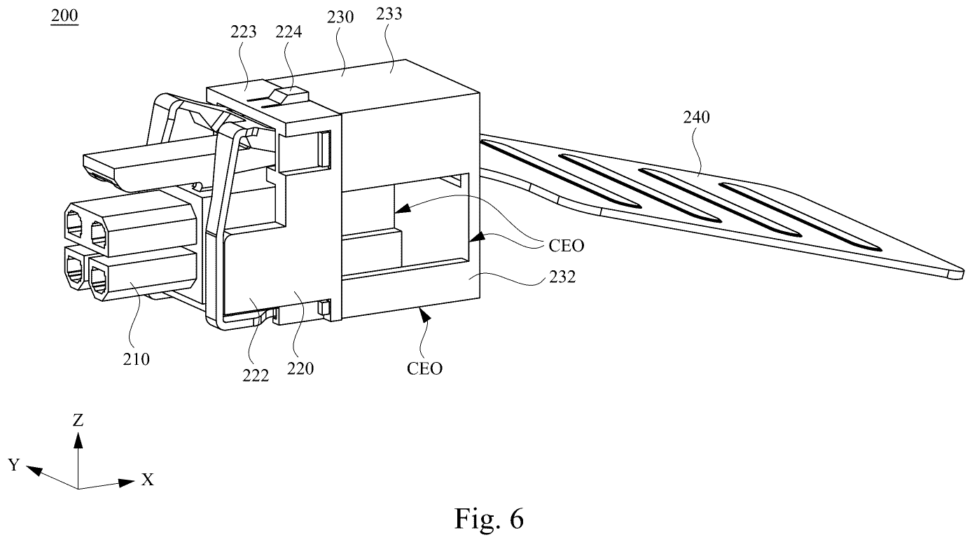

Reference is made to FIG. 6. In this embodiment, the connector 200 includes a terminal body 210, a first housing 220, a second housing 230, and a pull tab 240. Compared to the embodiment shown in FIG. 1, which is a rear-exit connector, this embodiment supports usage as a bottom-exit or side-exit connector that allows the cable to exit from below or from the side. In some embodiments, the connector 200 is a four-pin connector. Only the differences between the two embodiments will be described in detail below, and the same parts of the two embodiments should be referred to the description of the previous embodiment. The first housing 220 includes a first side plate 222, a first top plate 223, and a pressing arm 224. The pressing arm 224 extends from the first top plate 223. In some embodiments, a portion of the pressing arm 224 protrudes from an outer surface of the first top plate 223. The second housing 230 is engaged with the first housing 220. The second housing 230 includes a second side plate 232 and a second top plate 233. The second housing 230 has a plurality of cable exit openings CEO.

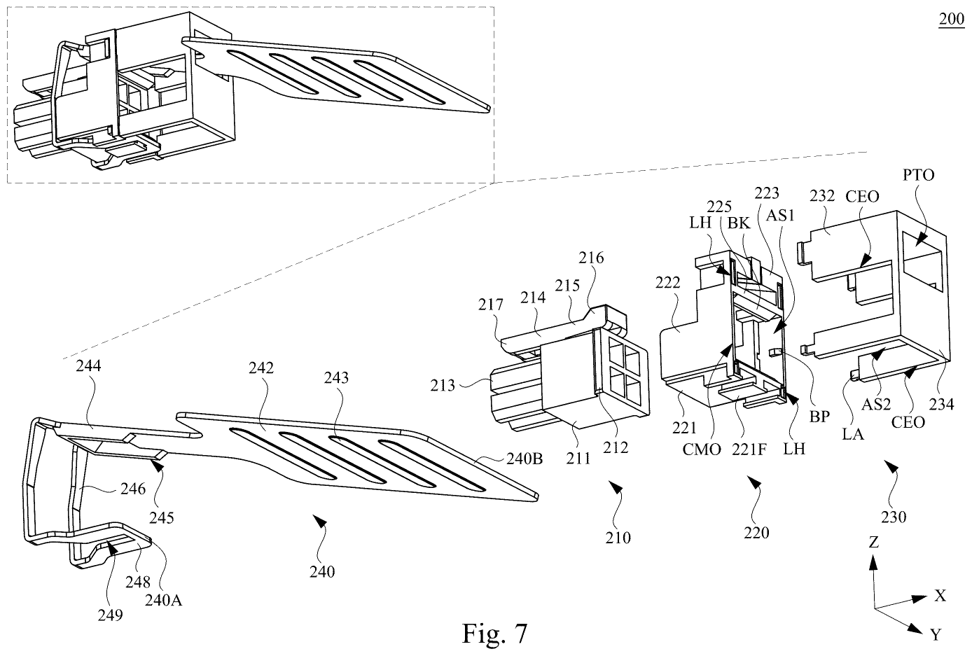

Reference is made to FIG. 7, which is another perspective view and an exploded view of the connector 200 in accordance with an embodiment of the present disclosure. In this embodiment, the first housing 220 further includes a first bottom plate 221 and a fixing bump 221F disposed on the first bottom plate 221. The second housing 230 further includes a second back plate 234 located at a side of the second housing 230 away from the first housing 220. A communicating opening CMO is formed between the first housing 220 and the second housing 230. The second housing 230 substantially has three cable exit openings CEO, two of which, serving as side-exit cable exit openings CEO, respectively run through the second side plates 232, and the other one, serving as a bottom-exit cable exit opening CEO, is defined by an edge of the first bottom plate 221, edges of the two second side plates 232, and an edge of the second back plate 234. The second housing 230 further has a pull tab exit PTO. The pull tab exit PTO runs through the second back plate 234. The pull tab 240 includes a grip portion 242, an actuating portion 244, a limiting opening 245, a strap portion 246, and a fixing portion 248. The fixing portion 248 is fixed to the fixing bump 221F of the first bottom plate 221. The strap portion 246 is connected to the fixing portion 248 and is adjacent to the two first side plates 222. The actuating portion 244 is connected to the strap portion 246 and at least passes through the first housing 220. The grip portion 242 is connected to the actuating portion 244 and passes through the pull tab exit PTO, being located outside the second housing 230. The limiting opening 245 is located on the actuating portion 244 and runs through the actuating portion 244.

Reference is made again to FIG. 7. In this embodiment, the terminal body 210 includes a main body 211, a flange 212, a mating portion 213, and a latch 214. The latch 214 includes an elastic arm 215, a pressing portion 216, and a hook 217. The first housing 220 further includes a beam 225, a blocking bar BK, and a blocking bump BP. The beam 225 is connected between the two first side plates 222. The blocking bar BK is disposed on the beam 225. The blocking bump BP is disposed on the first side plate 222. The blocking bar BK and the blocking bump BP are configured to block the flange 212. The first housing 220 further has a first accommodating space AS1 and a locking hole LH. The first bottom plate 221, the two first side plates 222, and the first top plate 223 define the first accommodating space AS1 of the first housing 220. In some embodiments, the beam 225 divides the first accommodating space AS1, such that the pull tab 240 passes through a space above the beam 225, and the terminal body 210 passes through a space below the beam 225. The second housing 230 further includes a locking arm LA, and the locking arm LA is engaged with the locking hole LH. The second housing 230 further has a second accommodating space AS2. The two second side plates 232, the second top plate 233, and the second back plate 234 define the second accommodating space AS2 of the second housing 230. The communicating opening CMO of the first housing 220 communicates the first accommodating space AS1 and the second accommodating space AS2.

Reference is made again to FIG. 7. In this embodiment, the grip portion 242 is connected to the actuating portion 244 and includes an anti-slip portion 243. The strap portion 246 is connected to a side of the actuating portion 244 away from the grip portion 242. Specifically, the strap portion 246 includes two straps respectively configured to abut against the two first side plates 222, such that the strap portion 246 presses against the first housing 220 when the pull tab 240 is pulled. The fixing portion 248 is connected to the strap portion 246 and has a fixing slot 249 running through the fixing portion 248. The fixing portion 248 is fixed to the fixing bump 221F of the first bottom plate 221 by the fixing slot 249. The pull tab 240 has a first end 240A and a second end 240B. The first end 240A is located on the grip portion 242, and the second end 240B is located on the fixing portion 248.

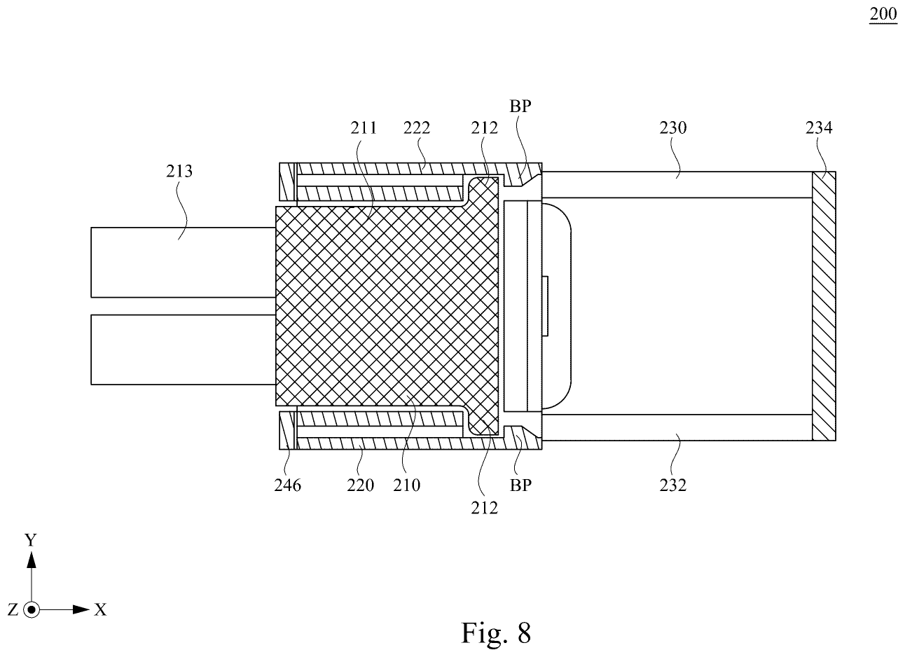

Reference is made to FIG. 8, which is a cross-sectional view of the connector 200 in accordance with an embodiment of the present disclosure. In this embodiment, the blocking bump BP is located at an end of the inner surface of the first side plate 222 close to the second housing 230, and the flange 212 is blocked by the blocking bump BP. Specifically, since a step is formed between the flange 212 and the main body 211, and a step also exists on the inner surface of the first side plate 222, the flange 212 can be limited by the step of the first side plate 222 and the blocking bump BP, thereby allowing the terminal body 210 to be positioned within the first housing 220. The strap portion 246 is adjacent to an end of the first side plate 222 away from the second housing 230.

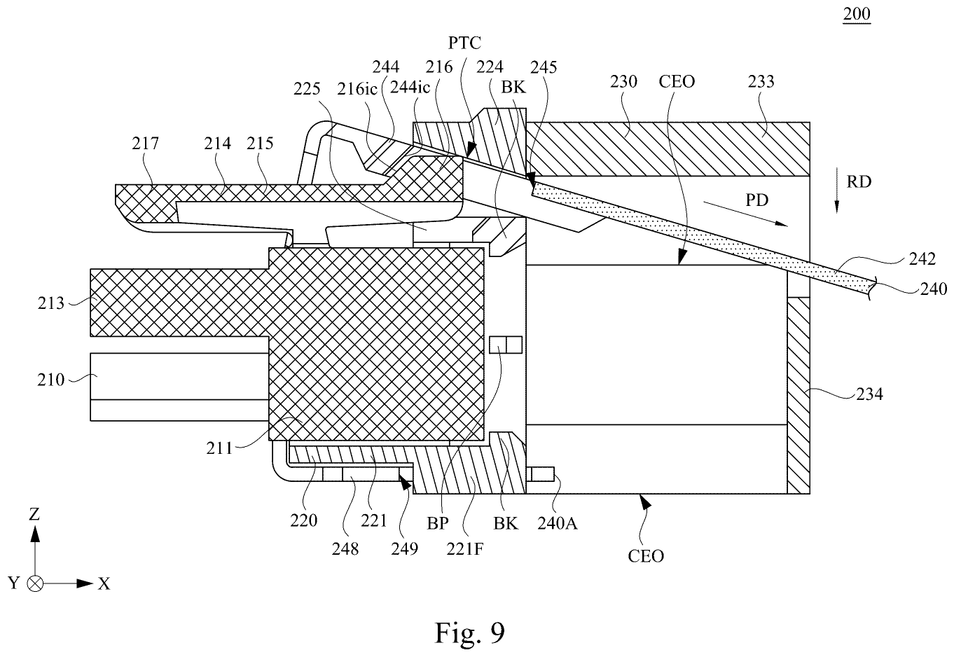

Reference is made to FIG. 9, which is another cross-sectional view of the connector 200 in accordance with an embodiment of the present disclosure. In this embodiment, the pressing portion 216 has an abutting inclined surface 216ic. The actuating portion 244 has an actuating inclined surface 244ic, and the actuating inclined surface 244ic is located on an inner surface of the limiting opening 245. When the pull tab 240 has not yet been pulled, the pressing portion 216 of the latch 214 is located in the limiting opening 245 of the actuating portion 244. As shown in FIG. 7 and FIG. 9, the first top plate 223 covers the actuating portion 244 and is located over the pressing portion 216, and a pull tab channel PTC is formed between the first top plate 223 and the beam 225 and configured to allow the actuating portion 244 of the pull tab 240 to pass through. When the pull tab 240 is pulled, the pull tab 240 moves away from the terminal body 210 along a pulling direction PD that forms an acute angle with direction X (i.e., not parallel to direction X). As the pull tab 240 moves away from the terminal body 210, the actuating inclined surface 244ic of the actuating portion 244 abuts against the abutting inclined surface 216ic of the pressing portion 216, such that the latch 214 seesaws relative to the main body 211. Specifically, an extending direction of the actuating inclined surface 244ic forms an acute angle with the pulling direction PD (i.e., the extending direction of the actuating inclined surface 244ic is neither perpendicular nor parallel to the pulling direction PD), such that the actuating portion 244 presses the pressing portion 216 of the latch 214 toward the main body 211 along a pressing direction RD that is generally parallel to direction Z, thereby causing the pressing portion 216 to move downward and the hook 217 to move upward.

In a usage scenario, a user may grip the grip portion 242 of the pull tab 240 and pull the pull tab 240 along the pulling direction PD, such that the actuating portion 244 of the pull tab 240 presses the pressing portion 216 of the latch 214 downward by the guiding of the actuating inclined surface 244ic and the abutting inclined surface 216ic, thereby causing the hook 217 to tilt upward and disengage from the connector at the other end. In another usage scenario, if the pull tab 240 breaks such that the user is unable to operate the pull tab 240 to allow the latch 214 to seesaw, the user may alternatively press a pressing arm 224 disposed on the first top plate 223 and located over the pressing portion 216. When the pressing arm 224 is pressed, it also presses the pressing portion 216 of the latch 214 downward, thereby causing the hook 217 to tilt upward and disengage from the connector at the other end.

Hereinafter, the structure and function of each component included in a connector 300 of this embodiment and the connection relationship between the components will be described in detail.

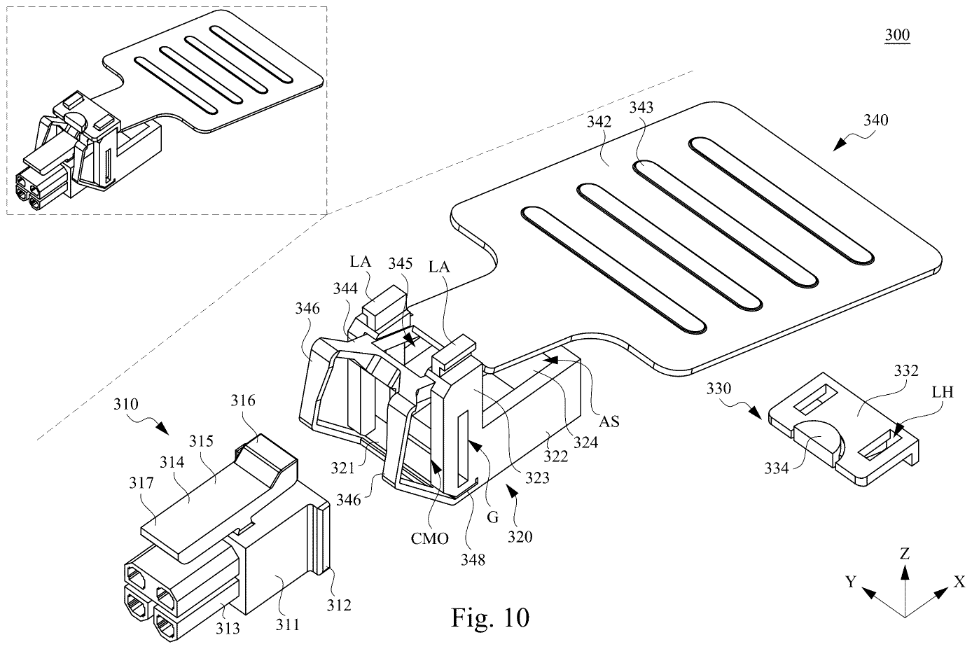

Reference is made to FIG. 10, which is a perspective view and an exploded view of a connector 300 in accordance with an embodiment of the present disclosure. In this embodiment, the connector 300 includes a terminal body 310, a housing 320, a retaining part 330, and a pull tab 340. The housing 320 accommodates the terminal body 310. The retaining part 330 is disposed on the housing 320. The pull tab 340 passes through the housing 320 and is configured to unlock the terminal body 310. Compared to the embodiment shown in FIG. 6, which may serve as a bottom-exit or side-exit connector, the present embodiment is solely a bottom-exit connector and includes only one housing. In some embodiments, the connector 300 is a four-pin connector. Only the differences between the two embodiments will be described in detail below, and the same parts of the two embodiments should be referred to the description of the previous embodiment.

Reference is made again to FIG. 10. In this embodiment, the terminal body 310 includes a main body 311, a flange 312, a mating portion 313, and a latch 314. The latch 314 includes an elastic arm 315, a pressing portion 316, and a hook 317. The housing 320 includes a bottom plate 321, two side plates 322 connected to the bottom plate 321, extending plates 323 extending from the two side plates 322, a back plate 324 connected to the two side plates 322, and a locking arm LA. In detail, the extending plates 323 extend away from the bottom plate 321 from one side of the side plates 322. The locking arm LA is disposed on the extending plates 323. The housing 320 further has an accommodating space AS, a positioning slot G, and a communicating opening CMO. The bottom plate 321, the two side plates 322, the extending plates 323, the back plate 324, and the retaining part 330 define the accommodating space AS of the housing 320. The positioning slot G runs through portions of the side plates 322 and the extending plates 323. The positioning slot G is engaged with the flange 312 located at at least one side of the main body 311. The communicating opening CMO communicates a terminal channel inside the terminal body 310 and the accommodating space AS of the housing 320. The retaining part 330 includes a retaining main body 332 and a pressing arm 334. The pressing arm 334 is disposed on the retaining main body 332. The extending plates 323 are engaged with the retaining part 330. Specifically, the retaining part 330 further has a locking hole LH, and the locking arm LA is engaged with the locking hole LH.

Reference is made again to FIG. 10. In this embodiment, the pull tab 340 includes a grip portion 342, an actuating portion 344, a strap portion 346, and a fixing portion 348. The grip portion 342 is connected to the actuating portion 344 and includes an anti-slip portion 343. The actuating portion 344 has a limiting opening 345. The strap portion 346 is connected to a side of the actuating portion 344 away from the grip portion 342 and is adjacent to the two side plates 322. Specifically, the strap portion 346 includes two straps respectively configured to abut against the two side plates 322, such that the strap portion 346 presses against the housing 320 when the pull tab 340 is pulled. The fixing portion 348 is connected between the strap portion 346 and the bottom plate 321. Specifically, an end of the fixing portion 348 is connected to the strap portion 346, and the other end of the fixing portion 348 is connected to the bottom plate 321. In some embodiments, the fixing portion 348 and the bottom plate 321 are integrally formed, but not limited thereto. Therefore, in some embodiments in which the fixing portion 348 and the bottom plate 321 are integrally formed, the housing 320 and the pull tab 340 are also integrally formed.

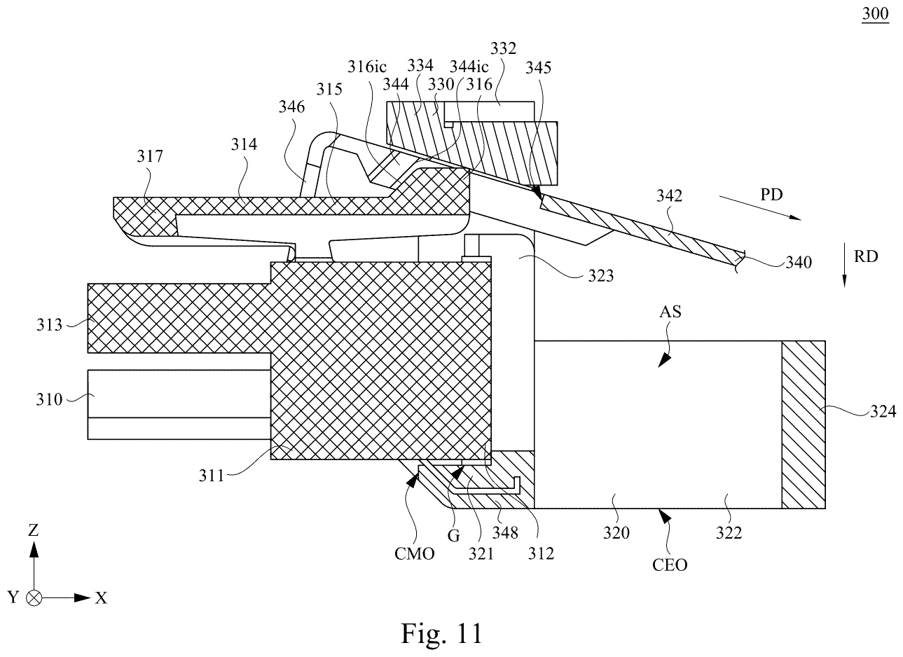

Reference is made to FIG. 11, which is a cross-sectional view of the connector 300 in accordance with an embodiment of the present disclosure. In this embodiment, the housing 320 has a cable exit opening CEO running through the bottom plate 321. The pressing portion 316 has an abutting inclined surface 316ic. The actuating portion 344 has an actuating inclined surface 344ic, and the actuating inclined surface 344ic is located on an inner surface of the limiting opening 345. When the pull tab 340 has not yet been pulled, the pressing portion 316 of the latch 314 is located in the limiting opening 345 of the actuating portion 344. When the pull tab 340 is pulled, it moves away from the terminal body 310 along a pulling direction PD that forms an acute angle with direction X (i.e., not parallel to direction X). As the pull tab 340 moves away from the terminal body 310, the actuating inclined surface 344ic of the actuating portion 344 abuts against the abutting inclined surface 316ic of the pressing portion 316, such that the latch 314 seesaws relative to the main body 311. Specifically, an extending direction of the actuating inclined surface 344ic forms an acute angle with the pulling direction PD (i.e., the extending direction of the actuating inclined surface 344ic is neither perpendicular nor parallel to the pulling direction PD), such that the actuating portion 344 presses the pressing portion 316 of the latch 314 toward the main body 311 along a pressing direction RD that is generally parallel to direction Z, thereby causing the pressing portion 316 to move downward and the hook 317 to move upward.

In a usage scenario, a user may grip the grip portion 342 of the pull tab 340 and pull the pull tab 340 along the pulling direction PD such that the actuating portion 344 of the pull tab 340 presses the pressing portion 316 of the latch 314 downward by the guiding of the actuating inclined surface 344ic and the abutting inclined surface 316ic, thereby causing the hook 317 to tilt upward and disengage from the connector at the other end. In another usage scenario, if the pull tab 340 breaks such that the user is unable to operate the pull tab 340 to allow the latch 314 to seesaw, the user may alternatively press a pressing arm 334 located over the pressing portion 316. When the pressing arm 334 is pressed, it also presses the pressing portion 316 of the latch 314 downward, thereby causing the hook 317 to tilt upward and disengage from the connector at the other end.

Hereinafter, the structure and function of each component included in a connector 400 of this embodiment and the connection relationship between the components will be described in detail.

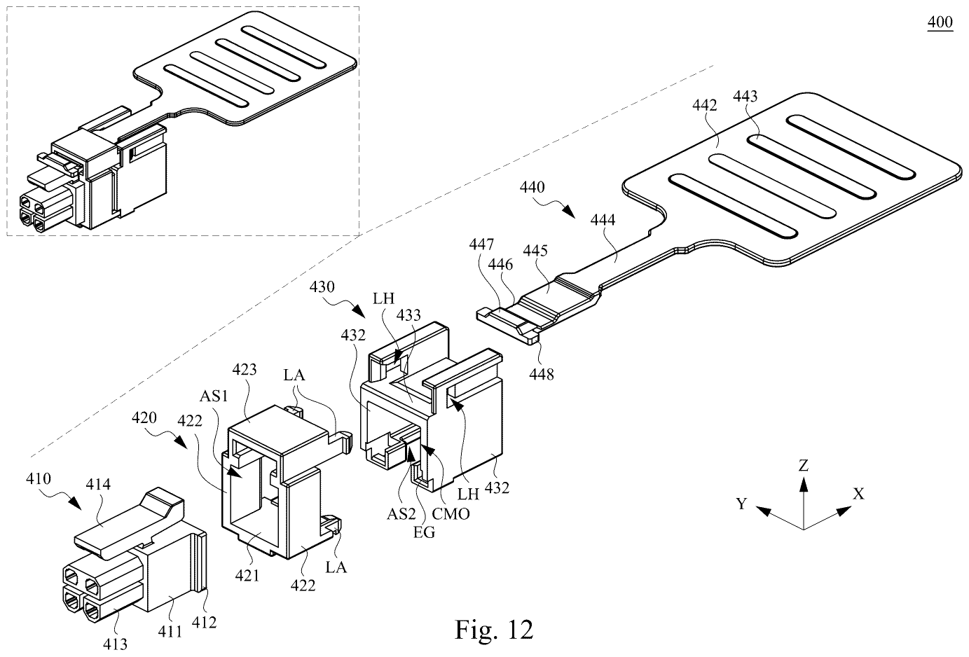

Reference is made to FIG. 12, which is a perspective view and an exploded view of a connector 400 in accordance with an embodiment of the present disclosure. In this embodiment, the connector 400 includes a terminal body 410, a first housing 420, a second housing 430, and a pull tab 440. The first housing 420 accommodates the terminal body 410. The second housing 430 is engaged with the first housing 420. The pull tab 440 at least passes through the first housing 420 and is configured to unlock the terminal body 410. Compared to the embodiment shown in FIG. 1, the pull tab 440 in this embodiment does not include any opening. In some embodiments, the connector 400 is a four-pin connector. Only the differences between the two embodiments will be described in detail below, and the same parts of the two embodiments should be referred to the description of the previous embodiment.

Reference is made again to FIG. 12. In this embodiment, the terminal body 410 includes a main body 411, a flange 412, a mating portion 413, and a latch 414. The first housing 420 includes a first bottom plate 421, two first side plates 422, a first top plate 423, and a locking arm LA. The first housing 420 has a first accommodating space AS1 accommodating the terminal body 410. The first bottom plate 421, the two first side plates 422, and the first top plate 423 define the first accommodating space AS1. The second housing 430 includes two second side plates 432, a second top plate 433, and an engaging portion EG. The second housing 430 has a second accommodating space AS2. The second accommodating space AS2 is at least defined by the two second side plates 432 and the second top plate 433. The second housing 430 further has a locking hole LH and a communicating opening CMO. The engaging portion EG and the locking hole LH are configured to be engaged with the locking arm LA of the first housing 420. The communicating opening CMO communicates the first accommodating space AS1 and the second accommodating space AS2.

Reference is made again to FIG. 12. In this embodiment, the pull tab 440 is configured to at least pass through the first accommodating space AS1 of the first housing 420 and includes a grip portion 442, a connecting portion 444, a horizontal portion 445, an actuating portion 446, a blocking portion 447, and an extending portion 448. The grip portion 442 includes an anti-slip portion 443. The connecting portion 444 is connected to one side of the grip portion 442. The horizontal portion 445 is connected to a side of the connecting portion 444 away from the grip portion 442. In other words, the connecting portion 444 is connected between the grip portion 442 and the horizontal portion 445. The actuating portion 446 is connected to a side of the horizontal portion 445 away from the connecting portion 444 and is configured to abut against the latch 414. Specifically, the connecting portion 444 and the horizontal portion 445 are connected between the grip portion 442 and the actuating portion 446. The blocking portion 447 is connected to a side of the actuating portion 446 away from the grip portion 442. The extending portion 448 is located at an end of the blocking portion 447 away from the grip portion 442 and laterally extends from the blocking portion 447.

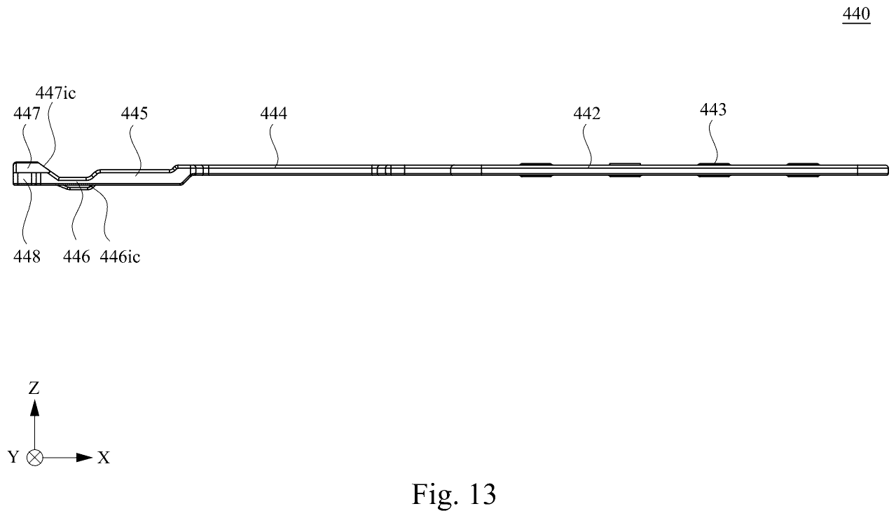

Reference is made to FIG. 13, which is a sided view of the pull tab 440 in accordance with an embodiment of the present disclosure. In this embodiment, the grip portion 442, the connecting portion 444, and the horizontal portion 445 extend in parallel along a direction (e.g., direction X). In some embodiments, a step is formed between the horizontal portion 445 and the connecting portion 444. Specifically, the horizontal portion 445 is generally lower than the grip portion 442 and the connecting portion 444. The actuating portion 446 has an actuating inclined surface 446ic, and the actuating inclined surface 446ic is a portion of a lower surface of the actuating portion 446. The actuating inclined surface 446ic is connected to the horizontal portion 445. The blocking portion 447 has a blocking inclined surface 447ic, and the blocking inclined surface 447ic is a portion of an upper surface of the blocking portion 447. In some embodiments, the thickness of the blocking portion 447 is greater than the thickness of the actuating portion 446. Therefore, when the pull tab 440 is excessively pulled, the blocking portion 447 and the extending portion 448 may be blocked by the first housing 420 to prevent the pull tab 440 from disengaging from the first housing 420.

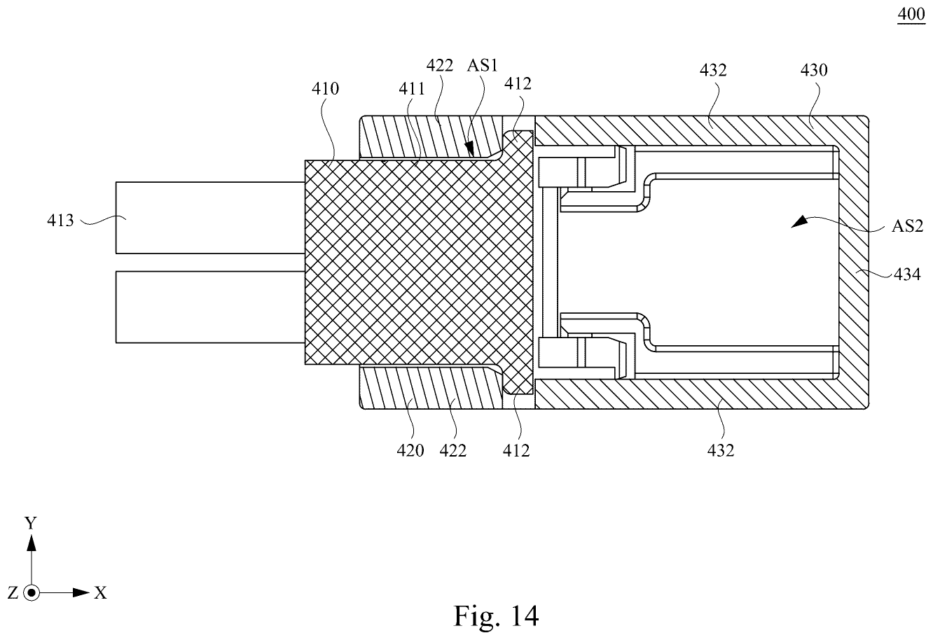

Reference is made to FIG. 14, which is a cross-sectional view of the connector 400 in accordance with an embodiment of the present disclosure. In this embodiment, the flange 412 is located at at least one side of the main body 411 and is located between the first housing 420 and the second housing 430. Therefore, the flange 412 can be limited by the first side plate 422 and the second side plate 432, thereby allowing the terminal body 410 to be positioned within the first housing 420 and the second housing 430.

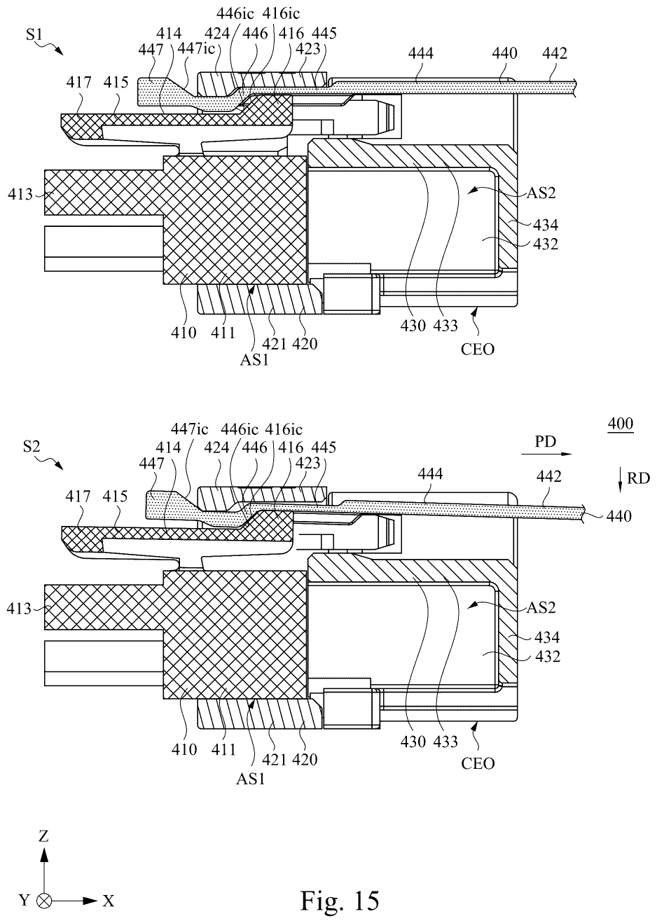

Reference is made to FIG. 15, which is a cross-sectional view of the connector 400 in a first state S1 and a second state S2 in accordance with an embodiment of the present disclosure. In this embodiment, the latch 414 further includes an elastic arm 415, a pressing portion 416, and a hook 417. The pressing portion 416 is located at an end of the elastic arm 415, and the hook 417 is located at the other end of the elastic arm 415. The first top plate 423 further includes a guiding bump 424. The second housing 430 further includes a second back plate 434. Therefore, the second accommodating space AS2 is substantially defined by the two second side plates 432, the second top plate 433, and the second back plate 434. The second housing 430 further includes a cable exit opening CEO defined by an edge of the first bottom plate 421, edges of the two second side plates 432, and an edge of the second back plate 434. The pull tab 440 passes through the first accommodating space AS1 such that the grip portion 442 is located outside the first housing 420. The pressing portion 416 has an abutting inclined surface 416ic. The actuating inclined surface 446ic faces the pressing portion 416 of the latch 414. The blocking inclined surface 447ic faces the guiding bump 424. When the connector 400 is in the first state S1, the pressing portion 416 of the latch 414 is located below the horizontal portion 445 of the pull tab 440, and the guiding bump 424 of the first top plate 423 is located over the actuating portion 446 of the pull tab 440. The grip portion 442 of the pull tab 440 is located outside the second accommodating space AS2 and over the second top plate 433.

Reference is made again to FIG. 15. In this embodiment, when the connector 400 is altered from the first state S1 to the second state S2, the pull tab 440 moves away from the terminal body 410 along a pulling direction PD that is generally parallel to direction X. When the pull tab 440 moves away from the terminal body 410, the actuating inclined surface 446ic of the actuating portion 446 abuts against the abutting inclined surface 416ic of the pressing portion 416, while the guiding bump 424 guides the blocking inclined surface 447ic, such that the latch 414 seesaws relative to the main body 411. Therefore, the actuating portion 446 presses the pressing portion 416 of the latch 414 toward the main body 411 along a pressing direction RD that is generally parallel to direction Z, thereby causing the pressing portion 416 to move downward and the hook 417 to move upward. In a usage scenario, a user may grip the grip portion 442 of the pull tab 440 and pull the pull tab 440 along the pulling direction PD such that the actuating portion 446 of the pull tab 440 presses the pressing portion 416 of the latch 414 downward by the guiding of the actuating inclined surface 446ic and the abutting inclined surface 416ic as well as the guiding of the guiding bump 424 and the blocking inclined surface 447ic, thereby causing the hook 417 to tilt upward and disengage from the connector at the other end.

Hereinafter, the structure and function of each component included in a connector 500 of this embodiment and the connection relationship between the components will be described in detail.

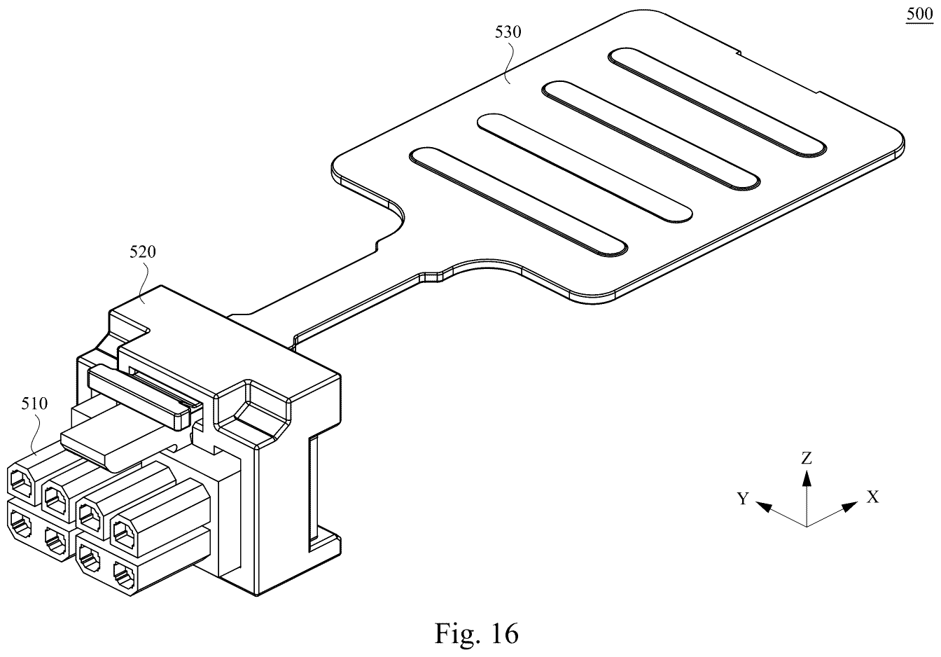

Reference is made to FIG. 16, which is a perspective view of a connector 500 in accordance with an embodiment of the present disclosure. In this embodiment, the connector 500 includes a terminal body 510, a housing 520, and a pull tab 530. The housing 520 accommodates the terminal body 510. The pull tab 530 passes through the housing 520 and is configured to unlock the terminal body 510. Compared with the embodiment shown in FIG. 12, which is also a rear-exit connector, the present embodiment includes only one housing. In some embodiments, the connector 500 is an eight-pin connector. Only the differences between the two embodiments will be described in detail below, and the same parts of the two embodiments should be referred to the description of the previous embodiment.

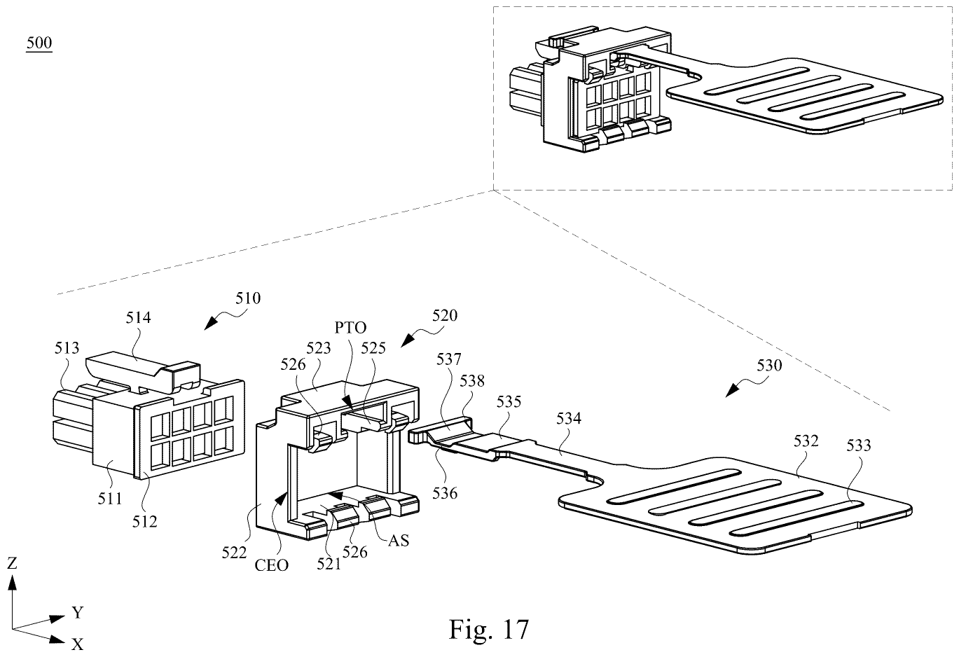

Reference is made to FIG. 17, which is another perspective view and an exploded view of the connector 500 in accordance with an embodiment of the present disclosure. In this embodiment, the terminal body 510 includes a main body 511, a flange 512, a mating portion 513, and a latch 514. The flange 512 is located at at least one side of the main body 511. The housing 520 includes a bottom plate 521, two side plates 522, a top plate 523, and an extending housing 525. The extending housing 525 extends from the top plate 523. The connector 500 further includes blocking arms 526 extending from the housing 520. In some embodiments, the blocking arms 526 are disposed on the bottom plate 521 and the top plate 523. The housing 520 has an accommodating space AS, a cable exit opening CEO, and a pull tab exit PTO. Specifically, the accommodating space AS of the housing 520 is defined by the bottom plate 521, the two side plates 522, and the top plate 523. The cable exit opening CEO is located at an end of the accommodating space AS facing the blocking arms 526. The pull tab exit PTO runs through the top plate 523. Specifically, the extending housing 525 extends from the top plate 523 toward the accommodating space AS, and an edge of the extending housing 525 and an edge of the top plate 523 jointly define the pull tab exit PTO. The pull tab 530 is configured to at least pass through the accommodating space AS of the housing 520 and includes a grip portion 532, a connecting portion 534, a horizontal portion 535, an actuating portion 536, a blocking portion 537, and an extending portion 538. The grip portion 532 includes an anti-slip portion 533.

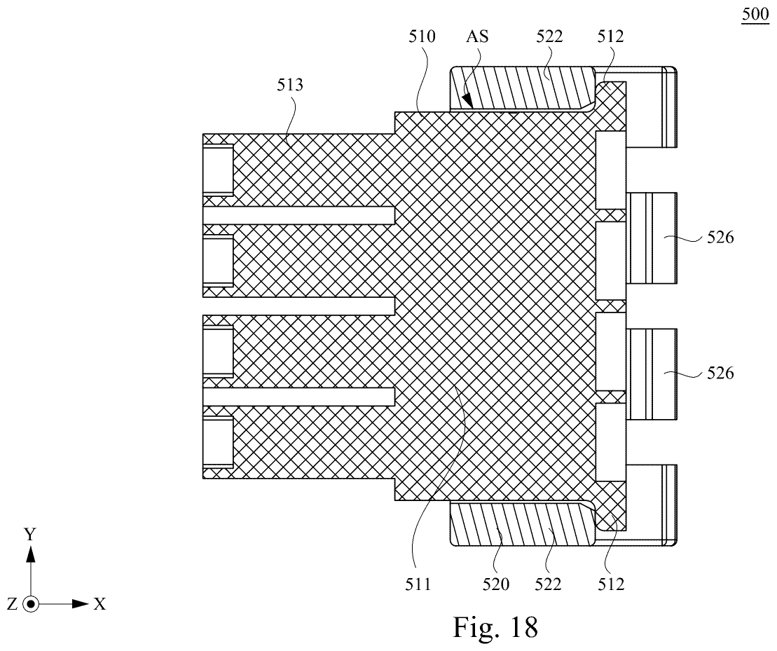

Reference is made to FIG. 18, which is a cross-sectional view of the connector 500 in accordance with an embodiment of the present disclosure. In this embodiment, the flange 512 is located between the housing 520 and an end of the blocking arms 526 away from the terminal body 510. Therefore, the flange 512 can be limited by the side plates 522 and the blocking arms 526, such that the terminal body 510 can be positioned in the housing 520.

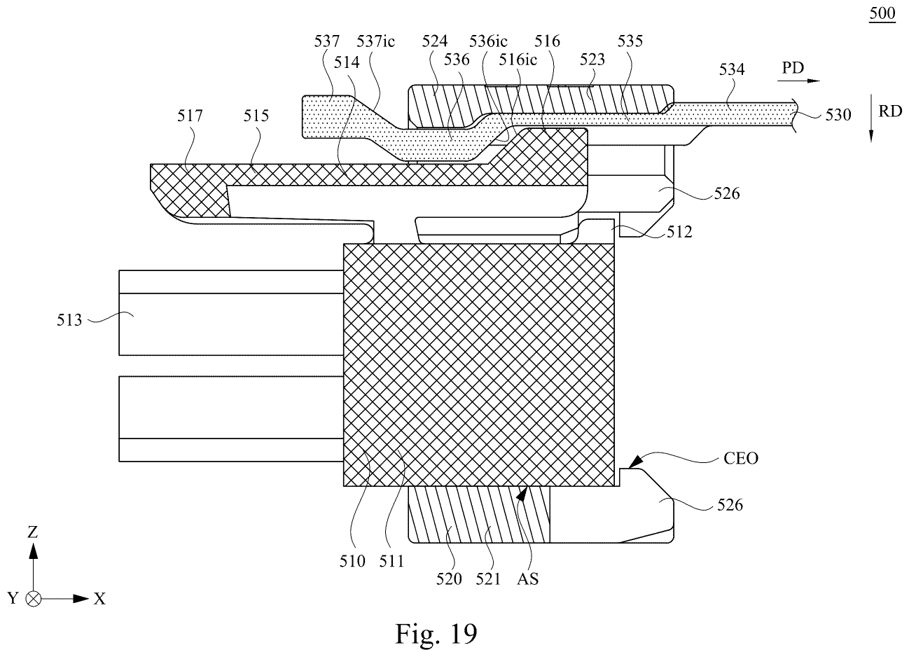

Reference is made to FIG. 19, which is another cross-sectional view of the connector 500 in accordance with an embodiment of the present disclosure. In this embodiment, the latch 514 further includes an elastic arm 515, a pressing portion 516, and a hook 517. The pressing portion 516 is located at an end of the elastic arm 515, and the hook 517 is located at the other end of the elastic arm 515. The top plate 523 further includes a guiding bump 524. The pressing portion 516 has an abutting inclined surface 516ic. The actuating inclined surface 536ic of the actuating portion 536 faces the pressing portion 516 of the latch 514. The blocking inclined surface 537ic of the blocking portion 537 faces the guiding bump 524. When the connector 500 has not yet been pulled, the pressing portion 516 of the latch 514 is located below the horizontal portion 535 of the pull tab 530, and the guiding bump 524 of the top plate 523 is located over the actuating portion 536 of the pull tab 530. The grip portion 532 of the pull tab 530 is located outside the accommodating space AS. When the pull tab 530 moves away from the terminal body 510, the actuating inclined surface 536ic of the actuating portion 536 abuts against the abutting inclined surface 516ic of the pressing portion 516, while the guiding bump 524 guides the blocking inclined surface 537ic, such that the latch 514 seesaws relative to the main body 511. Therefore, the actuating portion 536 presses the pressing portion 516 of the latch 514 toward the main body 511 along a pressing direction RD that is generally parallel to the Z direction, thereby causing the pressing portion 516 to move downward and the hook 517 to move upward.

In a usage scenario, a user may grip the grip portion 532 of the pull tab 530 and pull the pull tab 530 along the pulling direction PD, such that the actuating portion 536 of the pull tab 530 presses downward the pressing portion 516 of the latch 514 by the guiding of the actuating inclined surface 536ic and the abutting inclined surface 516ic as well as the guiding of the guiding bump 524 and the blocking inclined surface 537ic, thereby causing the hook 517 to tilt upward and disengage from the connector at the other end.

Hereinafter, the structure and function of each component included in a connector 600 of this embodiment and the connection relationship between the components will be described in detail.

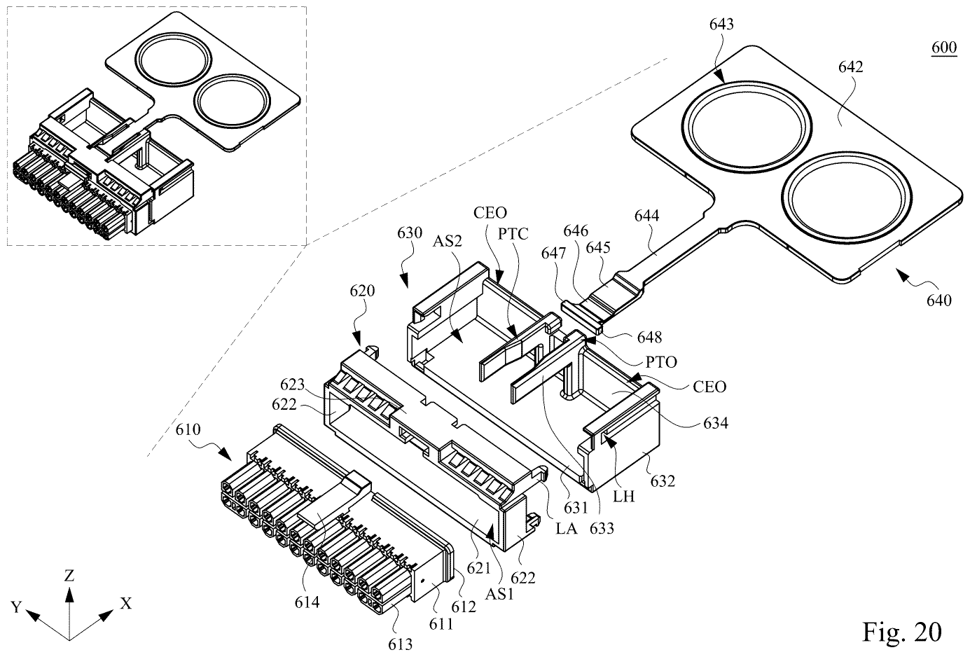

Reference is made to FIG. 20, which is a perspective view and an exploded view of a connector 600 in accordance with an embodiment of the present disclosure. In this embodiment, the connector 600 includes a terminal body 610, a first housing 620, a second housing 630, and a pull tab 640. The first housing 620 accommodates the terminal body 610. The second housing 630 is engaged with the first housing 620. The pull tab 640 at least passes through the first housing 620 and is configured to unlock the terminal body 610. A top of the second housing 630 has a pull tab channel PTC configured to allow the pull tab 640 to pass through, and the pull tab channel PTC is divided into two cable exit openings CEO. Compared with the embodiment shown in FIG. 12, which is a rear-exit connector, the present embodiment is a twenty-four-pin top-exit connector. Only the differences between the two embodiments will be described in detail below, and the same parts of the two embodiments should be referred to the description of the previous embodiment.

Reference is made again to FIG. 20. In this embodiment, the terminal body 610 includes a main body 611, a flange 612, a mating portion 613, and a latch 614. The flange 612 is located on at least one side of the main body 611 and protrudes from an outer surface of the main body 611. In some embodiments, the flange 612 surrounds all four sides of the main body 611. The first housing 620 includes a first bottom plate 621, two first side plates 622, a first top plate 623, and a locking arm LA. The first housing 620 has a first accommodating space AS1 accommodating the terminal body 610. Specifically, the first bottom plate 621, the two first side plates 622, and the first top plate 623 define the first accommodating space AS1. The second housing 630 includes a second bottom plate 631, two second side plates 632, an extending housing 633, and a second back plate 634. The extending housing 633 is connected to the second back plate 634 and defines the pull tab channel PTC. Specifically, the pull tab 640 passes through the pull tab channel PTC defined by the extending housing 633, and the pull tab channel PTC divides the second accommodating space AS2 to form two cable exit openings CEO. The second housing 630 has a second accommodating space AS2. Specifically, the second accommodating space AS2 is defined at least by the second bottom plate 631, the two second side plates 632, the extending housing 633, and the second back plate 634. The second housing 630 further has a pull tab exit PTO and a locking hole LH. The pull tab exit PTO is located at an end of the pull tab channel PTC away from the first housing 620. The locking hole LH is configured to be engaged with the locking arm LA of the first housing 620.

Reference is again made to FIG. 20. In this embodiment, the pull tab 640 includes a grip portion 642, a connecting portion 644, a horizontal portion 645, an actuating portion 646, a blocking portion 647, and an extending portion 648. The structural configuration of the pull tab 640 is similar to the structural configuration of the pull tab 440, the difference in between is that the grip portion 642 includes a pulling hole 643 instead of the anti-slip portion 443. The pulling hole 643 runs through the grip portion 642.

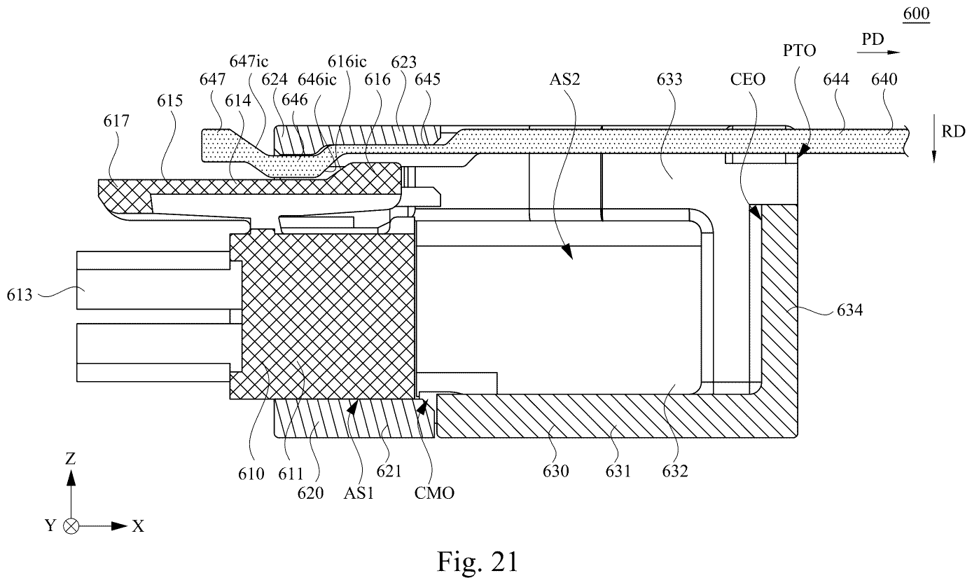

Reference is made to FIG. 21, which is a cross-sectional view of the connector 600 in accordance with an embodiment of the present disclosure. In this embodiment, the latch 614 further includes an elastic arm 615, a pressing portion 616, and a hook 617. The pressing portion 616 is located at an end of the elastic arm 615, and the hook 617 is located at the other end of the elastic arm 615. The second housing 630 has a communicating opening CMO that communicates the first accommodating space AS1 and the second accommodating space AS2. The first top plate 623 further includes a guiding bump 624. The pressing portion 616 has an abutting inclined surface 616ic. The actuating inclined surface 646ic of the actuating portion 646 faces the pressing portion 616 of the latch 614. The blocking inclined surface 647ic of the blocking portion 647 faces the guiding bump 624. When the connector 600 has not yet been pulled, the pressing portion 616 of the latch 614 is located below the horizontal portion 645 of the pull tab 640, and the guiding bump 624 of the first top plate 623 is located over the actuating portion 646 of the pull tab 640. When the pull tab 640 moves away from the terminal body 610, the actuating inclined surface 646ic of the actuating portion 646 abuts against the abutting inclined surface 616ic of the pressing portion 616, while the guiding bump 624 guides the blocking inclined surface 647ic, such that the latch 614 seesaws relative to the main body 611. Therefore, the actuating portion 646 presses the pressing portion 616 of the latch 614 toward the main body 611 along a pressing direction RD that is generally parallel to the Z direction, thereby causing the pressing portion 616 to move downward and the hook 617 to move upward.

In a usage scenario, as shown in FIG. 20 and FIG. 21, a user may use a finger to hook the pulling hole 643 of the pull tab 640 and pull the pull tab 640 along the pulling direction PD, such that the actuating portion 646 of the pull tab 640 presses downward the pressing portion 616 of the latch 614 by the guiding of the actuating inclined surface 646ic and the abutting inclined surface 616ic as well as the guiding of the guiding bump 624 and the blocking inclined surface 647ic, thereby causing the hook 617 to tilt upward and disengage from the connector at the other end.

Hereinafter, the structure and function of each component included in a connector 700 of this embodiment and the connection relationship between the components will be described in detail.

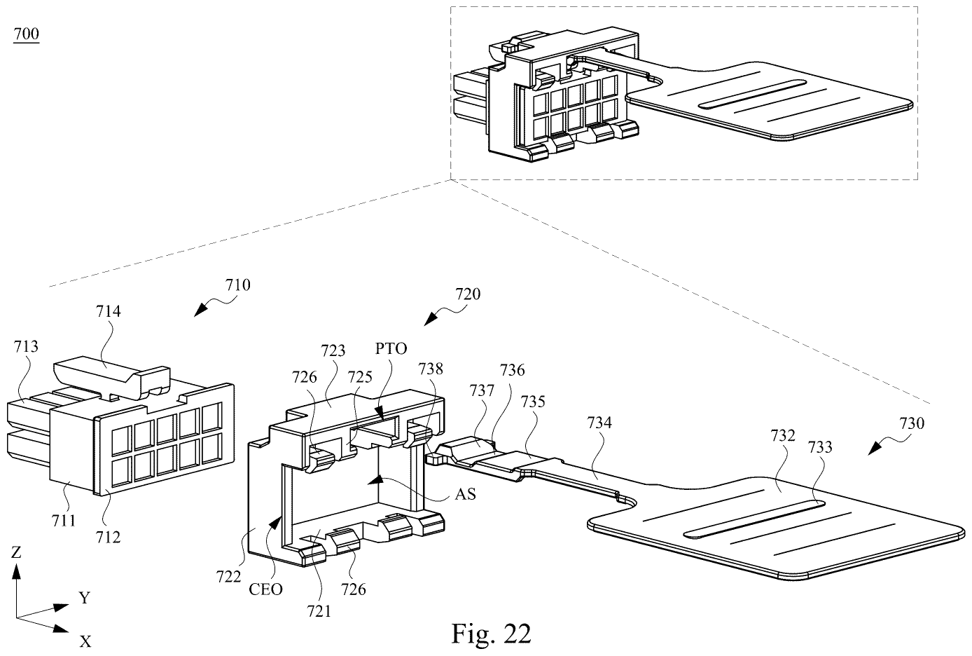

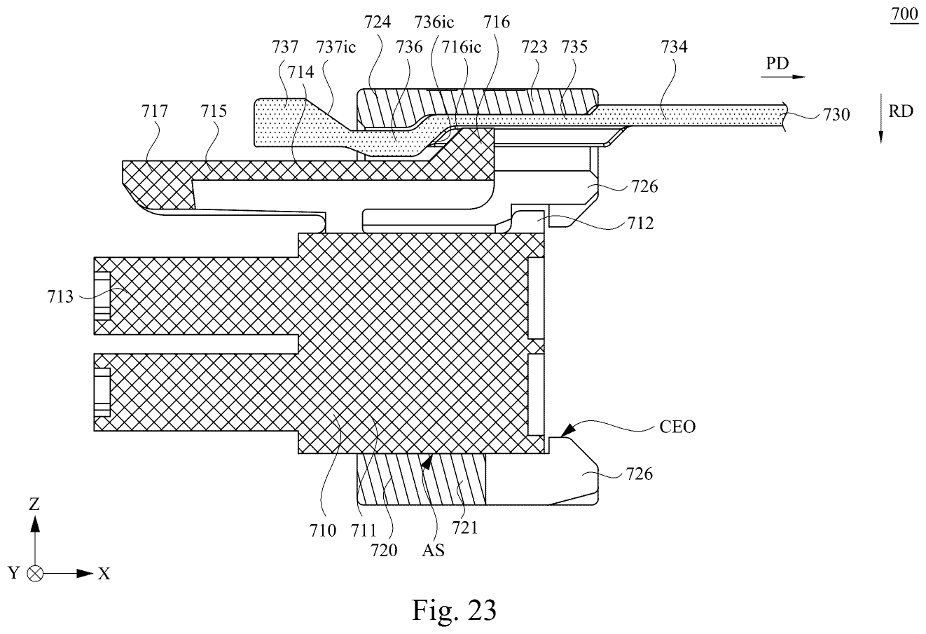

Reference is made to FIG. 22 and FIG. 23, which are a perspective view, exploded view, and cross-sectional view of a connector 700 in accordance with an embodiment of the present disclosure. Compared to the embodiment shown in FIG. 12, which is a rear-exit connector with four pins, the present embodiment is a ten-pin rear-exit connector. Only the differences between the two embodiments will be described in detail below, and the same parts of the two embodiments should be referred to the description of the previous embodiment.

As shown in FIG. 22, in this embodiment, the connector 700 includes a terminal body 710, a housing 720, and a pull tab 730. The terminal body 710 includes a main body 711, a flange 712, a mating portion 713, and a latch 714. The housing 720 includes a bottom plate 721, two side plates 722, a top plate 723, and an extending housing 725. The extending housing 725 extends from the top plate 723. The connector 700 further includes blocking arms 726 extending from the housing 720. The housing 720 has an accommodating space AS, a cable exit opening CEO, and a pull tab exit PTO. Specifically, the accommodating space AS of the housing 720 is defined by the bottom plate 721, two side plates 722, and the top plate 723. The cable exit opening CEO is located at an end of the accommodating space AS facing the blocking arms 726. The pull tab exit PTO runs through the top plate 723. Specifically, the extending housing 725 extends from the top plate 723 into the accommodating space AS, and an edge of the extending housing 725 and an edge of the top plate 723 jointly define the pull tab exit PTO. The pull tab 730 is configured to pass through at least the accommodating space AS of the housing 720 and includes a grip portion 732, a connecting portion 734, a horizontal portion 735, an actuating portion 736, a blocking portion 737, and an extending portion 738. The grip portion 732 includes an anti-slip portion 733.

As shown in FIG. 23, in this embodiment, the latch 714 further includes an elastic arm 715, a pressing portion 716, and a hook 717. The top plate 723 further includes a guiding bump 724. The pressing portion 716 has an abutting inclined surface 716ic. When the connector 700 has not yet been pulled, the pressing portion 716 of the latch 714 is located below the horizontal portion 735 of the pull tab 730, and the guiding bump 724 of the top plate 723 is located over the actuating portion 736 of the pull tab 730. When the pull tab 730 moves away from the terminal body 710, the actuating inclined surface 736ic of the actuating portion 736 abuts against the abutting inclined surface 716ic of the pressing portion 716, while the guiding bump 724 guides the blocking inclined surface 737ic, such that the latch 714 seesaws relative to the main body 711. Therefore, the actuating portion 736 presses the pressing portion 716 of the latch 714 toward the main body 711 along a pressing direction RD that is generally parallel to the Z direction, thereby causing the pressing portion 716 to move downward and the hook 717 to move upward.

In a usage scenario, a user may grip the grip portion 732 of the pull tab 730 and pull the pull tab 730 along a pulling direction PD, such that the actuating portion 736 of the pull tab 730 presses the pressing portion 716 of the latch 714 downward by the guiding of the actuating inclined surface 736ic and the abutting inclined surface 716ic as well as the guiding of the guiding bump 724 and the blocking inclined surface 737ic, thereby causing the hook 717 to tilt upward and disengage from the connector at the other end.

Hereinafter, the structure and function of each component included in a connector 800 of this embodiment and the connection relationship between the components will be described in detail.

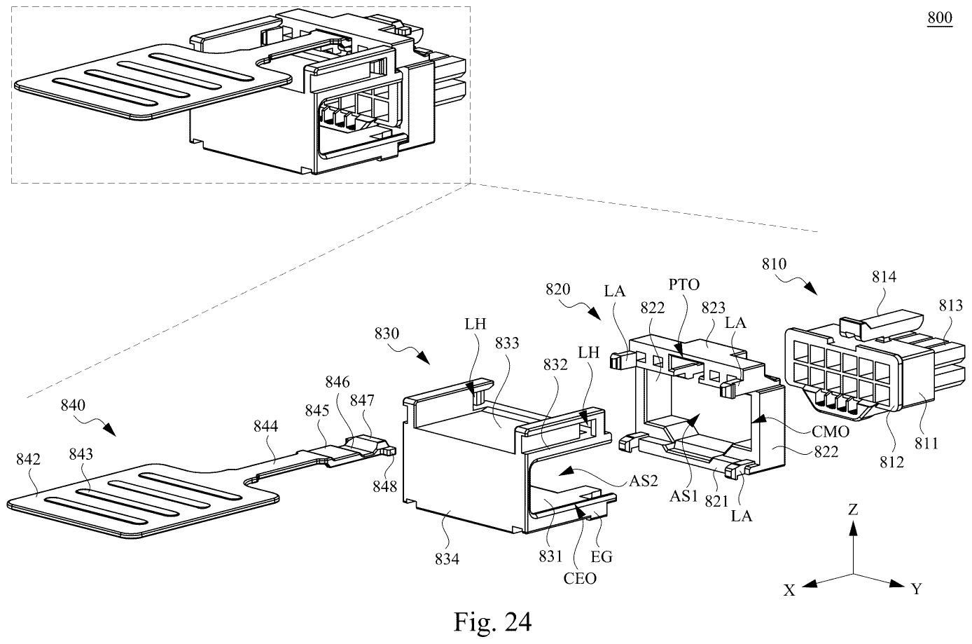

Reference is made to FIG. 24, which is a perspective view and exploded view of a connector 800 in accordance with an embodiment of the present disclosure. In this embodiment, the connector 800 includes a terminal body 810, a first housing 820, a second housing 830, and a pull tab 840. The first housing 820 accommodates the terminal body 810. The second housing 830 is engaged with the first housing 820. The pull tab 840 passes through the first housing 820 and is configured to unlock the terminal body 810. Compared to the embodiment shown in FIG. 12, which is a rear-exit connector, the present embodiment is a twelve-pin side-exit connector. Only the differences between the two embodiments will be described in detail below, and the same parts of the two embodiments should be referred to the description of the previous embodiment.

Reference is made again to FIG. 24. In this embodiment, the terminal body 810 includes a main body 811, a flange 812, a mating portion 813, and a latch 814. The first housing 820 includes a first bottom plate 821, two first side plates 822, a first top plate 823, and a locking arm LA. The first housing 820 has a first accommodating space AS1 accommodating the terminal body 810. Specifically, the first bottom plate 821, the two first side plates 822, and the first top plate 823 define the first accommodating space AS1. The second housing 830 includes a second bottom plate 831, two second side plates 832, a second top plate 833, and a second back plate 834. The second housing 830 has a cable exit opening CEO and a second accommodating space AS2. Specifically, the second accommodating space AS2 is defined by the second bottom plate 831, the two second side plates 832, the second top plate 833, and the second back plate 834. The cable exit opening CEO runs through one of the two second side plates 832. In other words, the second housing 830 has only one cable exit opening CEO. The second housing 830 further has a locking hole LH, which is configured to be engaged with the locking arm LA of the first housing 820. The first housing 820 further has a communicating opening CMO and a pull tab exit PTO. The communicating opening CMO communicates the first accommodating space AS1 and the second accommodating space AS2. The pull tab exit PTO runs through the first top plate 823. The pull tab 840 includes a grip portion 842, a connecting portion 844, a horizontal portion 845, an actuating portion 846, a blocking portion 847, and an extending portion 848.

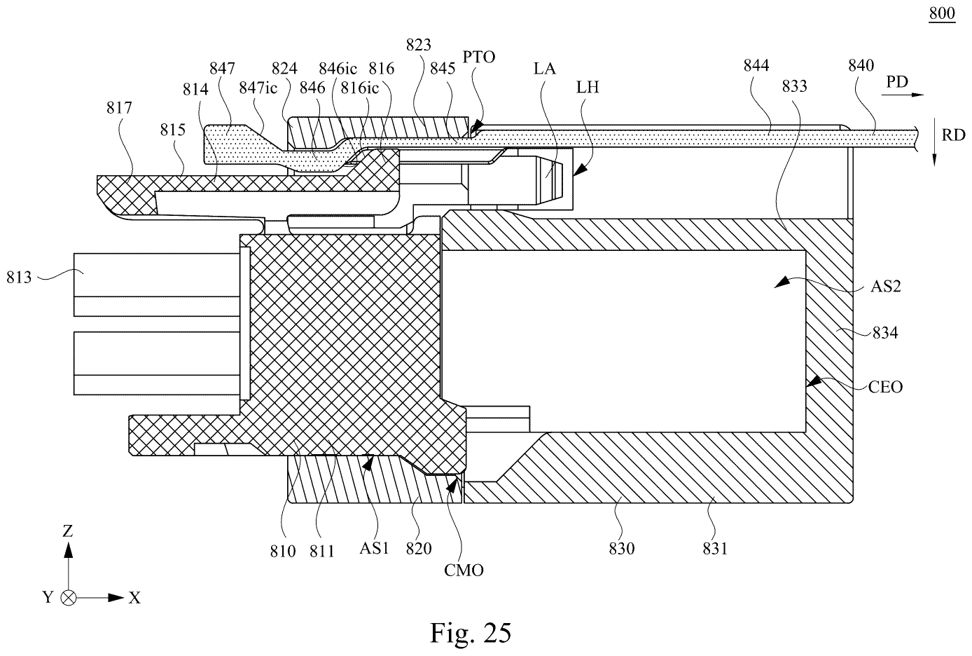

Reference is made to FIG. 25, which is a cross-sectional view of the connector 800 in accordance with an embodiment of the present disclosure. In this embodiment, the latch 814 further includes an elastic arm 815, a pressing portion 816, and a hook 817. The first top plate 823 further includes a guiding bump 824. The pressing portion 816 has an abutting inclined surface 816ic. When the connector 800 has not yet been pulled, the pressing portion 816 of the latch 814 is located below the horizontal portion 845 of the pull tab 840, and the guiding bump 824 of the first top plate 823 is located over the actuating portion 846 of the pull tab 840. When the pull tab 840 moves away from the terminal body 810, the actuating inclined surface 846ic of the actuating portion 846 abuts against the abutting inclined surface 816ic of the pressing portion 816, while the guiding bump 824 guides the blocking inclined surface 847ic, such that the latch 814 seesaws relative to the main body 811. Therefore, the actuating portion 846 presses the pressing portion 816 of the latch 814 toward the main body 811 along a pressing direction RD that is generally parallel to the Z direction, thereby causing the pressing portion 816 to move downward and the hook 817 to move upward.

In a usage scenario, as shown in FIG. 24 and FIG. 25, a user may grip the grip portion 842 of the pull tab 840 and pull the pull tab 840 along a pulling direction PD, such that the actuating portion 846 of the pull tab 840 presses the pressing portion 816 of the latch 814 downward by the guiding of the actuating inclined surface 846ic and the abutting inclined surface 816ic as well as the guiding of the guiding bump 824 and the blocking inclined surface 847ic, thereby causing the hook 817 to tilt upward and disengage from the connector at the other end.

From the above detailed description of the specific embodiments of the present disclosure, it can be clearly seen that in the connector of the present disclosure, since the latch of the terminal body includes a pressing portion having an abutting inclined surface and the actuating portion of the pull tab includes an actuating inclined surface, when the pull tab is pulled to move in a direction away from the terminal body, the actuating inclined surface of the actuating portion abuts against the abutting inclined surface of the pressing portion, thereby causing both ends of the latch to seesaw, and thus achieving the purpose of unlocking the connector. In the connector of the present disclosure, since the blocking portion of the pull tab includes a guiding inclined surface, and the housing includes a guiding bump disposed corresponding to the guiding inclined surface, when the pull tab is pulled to move in a direction away from the terminal body, the guiding inclined surface of the blocking portion is guided by the guiding bump of the housing, thereby causing the actuating portion to press the pressing portion of the latch toward the main body, and thus achieving the effect of ensuring that the hook of the latch reliably disengages from the connector at the other end. Overall, the connector of the present disclosure can achieve the effect of making the insertion and removal operation of the entire connector more effortless.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A connector comprising:
a terminal body comprising a main body and a latch disposed on the main body, the latch comprising an elastic arm, a pressing portion located at an end of the elastic arm, and a hook located at the other end of the elastic arm, wherein the pressing portion has an abutting inclined surface;
a first housing having a first accommodating space accommodating the terminal body; and
a pull tab passing through the first accommodating space, and the pull tab comprising an actuating portion and a limiting opening located on the actuating portion, wherein the actuating portion has an actuating inclined surface, and the actuating inclined surface is located on an inner surface of the limiting opening,
wherein when the pull tab moves away from the terminal body, the actuating inclined surface abuts against the abutting inclined surface, such that the latch seesaws relative to the main body.

2. The connector of claim 1, further comprising a second housing engaged with the first housing, and the second housing having a second accommodating space, wherein the terminal body further comprises a flange located at at least one side of the main body, and the flange is located between the first housing and the second housing.

3. The connector of claim 2, wherein the first housing comprises a first bottom plate, two first side plates, and a first top plate defining the first accommodating space, and the second housing comprises two second side plates, a second top plate, and a second back plate defining the second accommodating space, wherein the second housing has a cable exit opening defined by an edge of the first bottom plate, edges of the two second side plates, and an edge of the second back plate and has a communicating opening communicating the first accommodating space and the second accommodating space.

4. The connector of claim 2, wherein the pull tab further comprises:
a grip portion located outside the second housing and comprising an anti-slip portion, wherein an extending direction of the grip portion forms an acute angle with an extending direction of the actuating portion;
a connecting portion connected between the grip portion and the actuating portion; and
an extending portion located at an end of the actuating portion away from the grip portion and laterally extending from the actuating portion,
wherein the extending portion has a first thickness, the connecting portion has a second thickness, and the actuating portion has a third thickness, wherein the third thickness is greater than the second thickness and less than the first thickness.

5. The connector of claim 1, further comprising a second housing engaged with the first housing, and the second housing having a second accommodating space, wherein the terminal body further comprises a flange located at at least one side of the main body, and the first housing comprises a blocking bar and a blocking bump blocking the flange.

6. The connector of claim 5, wherein the first housing comprises a first bottom plate, two first side plates, and a first top plate defining the first accommodating space, and the second housing comprises two second side plates, a second top plate, and a second back plate defining the second accommodating space, wherein the first housing has a communicating opening communicating the first accommodating space and the second accommodating space, and the second housing has a first cable exit opening defined by an edge of the first bottom plate, edges of the two second side plates, and an edge of the second back plate, a second cable exit opening running through the second side plates, and a pull tab exit running through the second back plate.

7. The connector of claim 6, wherein the first housing further comprises a pressing arm extending from the first top plate and located over the pressing portion, and a portion of the pressing arm protrudes from an outer surface of the first top plate.

8. The connector of claim 6, wherein the pull tab further comprises:
a grip portion connected to the actuating portion and comprising an anti-slip portion;
a strap portion connected to a side of the actuating portion away from the grip portion and adjacent to the two first side plates; and
a fixing portion connected to the strap portion and having a fixing slot running through the fixing portion, and the fixing portion being fixed to a fixing bump of the first bottom plate by the fixing slot,
wherein a first end of the pull tab is located on the grip portion, and a second end of the pull tab is located on the fixing portion.

9. The connector of claim 1, wherein the terminal body further comprises a flange located at at least one side of the main body, and the first housing has a positioning slot engaged with the flange.

10. The connector of claim 9, further comprising a retaining part disposed on the first housing, wherein the first housing comprises a first bottom plate, two first side plates connected to the first bottom plate, a first back plate connected to the two first side plates, and an extending plate extending from the two first side plates and engaged with the retaining part, and the first bottom plate, the two first side plates, the first back plate, the extending plate, and the retaining part define the first accommodating space, wherein the first housing has a communicating opening communicating with the first accommodating space and a cable exit opening running through the first bottom plate, and wherein the retaining part further comprises a pressing arm located over the pressing portion.

11. The connector of claim 10, wherein the pull tab further comprises:
a grip portion connected to the actuating portion and comprising an anti-slip portion;
a strap portion connected to a side of the actuating portion away from the grip portion and adjacent to the two first side plates; and
a fixing portion connected to the strap portion, and the fixing portion being integrally formed with the first bottom plate.

12. A connector comprising:
a terminal body comprising a main body and a latch disposed on the main body, and the latch comprising an elastic arm, a pressing portion located at an end of the elastic arm, and a hook located at the other end of the elastic arm, wherein the pressing portion has an abutting inclined surface;
a first housing having a first accommodating space accommodating the terminal body; and
a pull tab passing through the first accommodating space and comprising an actuating portion, wherein the actuating portion has an actuating inclined surface facing the latch,
wherein when the pull tab moves away from the terminal body, the actuating inclined surface abuts against the abutting inclined surface, such that the latch seesaws relative to the main body.

13. The connector of claim 12, further comprising a second housing engaged with the first housing, and the second housing having a second accommodating space, wherein the terminal body further comprises a flange located at at least one side of the main body, and the flange is located between the first housing and the second housing.

14. The connector of claim 13, wherein the first housing comprises a first bottom plate, two first side plates, and a first top plate defining the first accommodating space, and the second housing comprises two second side plates, a second top plate, and a second back plate defining the second accommodating space, wherein the second housing has a cable exit opening defined by an edge of the first bottom plate, edges of the two second side plates, and an edge of the second back plate and has a communicating opening communicating the first accommodating space and the second accommodating space.

15. The connector of claim 13, wherein the first housing comprises a first bottom plate, two first side plates, and a first top plate defining the first accommodating space, and the second housing comprises a second bottom plate, two second side plates, a second back plate, and an extending housing connected to the second back plate and defining a pull tab channel, defining the second accommodating space, wherein the pull tab channel divides the second accommodating space to form a first cable exit opening and a second cable exit opening, wherein the second housing has a pull tab exit located at an end of the pull tab channel away from the first housing and has a communicating opening communicating the first accommodating space and the second accommodating space.

16. The connector of claim 13, wherein the first housing comprises a first bottom plate, two first side plates, and a first top plate defining the first accommodating space, and the second housing comprises a second bottom plate, two second side plates, a second top plate, and a second back plate defining the second accommodating space, wherein the first housing has a pull tab exit running through the first top plate and a communicating opening communicating the first accommodating space and the second accommodating space, and the second housing has a cable exit opening running through one of the two second side plates.

17. The connector of claim 12, further comprising a blocking arm extending from the first housing, wherein the terminal body further comprises a flange located at at least one side of the main body, and the flange is located between an end of the blocking arm away from the terminal body and the first housing.

18. The connector of claim 17, wherein the first housing comprises a first bottom plate, two first side plates, and a first top plate defining the first accommodating space, wherein the first housing has a cable exit opening located at an end of the first accommodating space facing the blocking arm and a pull tab exit running through the first top plate.

19. The connector of claim 12, wherein the pull tab further comprises:
a grip portion located outside the first housing;
a connecting portion connected between the grip portion and the actuating portion;
a blocking portion connected to a side of the actuating portion away from the grip portion and having a blocking inclined surface, wherein a thickness of the blocking portion is greater than a thickness of the actuating portion; and
an extending portion located at an end of the blocking portion away from the grip portion and laterally extending from the blocking portion.

20. The connector of claim 19, wherein the first housing further comprises a guiding bump, and when the pull tab moves away from the terminal body, the guiding bump guides the blocking inclined surface, such that the actuating portion presses the pressing portion toward the main body.
